(19) United States
(12) Patent Application Publication
(10) Pub. No.: US 2025/0206495 A1
(43) Pub. Date: Jun. 26, 2025

(54) PLANAR COMPOSITE WITH GROOVES FOR DIMENSIONALLY STABLE FOODSTUFF CONTAINERS WITH STEEP EDGES RUNNING AT AN ANGLE TO EACH OTHER

(71) Applicant: SIG Services AG, Neuhausen am Rheinfall (CH)

(72) Inventor: Thomas Keck, Aachen (DE)

(21) Appl. No.: 18/846,201

(22) PCT Filed: Mar. 11, 2022
(86) PCT No.: PCT/CN2022/080340

§ 371 Date: Sep. 11, 2024

(51) Int. Cl. B65D 5/56; B65D 5/06; B65D 5/40

(52) U.S. Cl. CPC B65D 5/563; B65D 5/067; B65D 5/40

(57) ABSTRACT

The invention relates to a planar composite comprising
a. a carrier layer,
b. a barrier layer, and
c. an inner polymer layer;
   wherein the planar composite includes at least a first plurality of grooves arranged and configured such that at least a part of a container wall of a closed container is obtainable by folding along the grooves and joining portions; wherein the closed container includes a standing base and a head portion; wherein the head portion includes at least 3 head side surfaces inclined to each other in a longitudinal direction such that the closed container tapers at least in sections in the head portion; wherein a perimeter of each of the head side surfaces is respectively formed by a plurality of side edges; wherein each of the plurality of side edges includes a pair of steep edges; wherein each pair of steep edges is formed along a pair of grooves; wherein the grooves of each of the pairs of grooves are at an angle in the range from 40 to 60° to one other. The invention further relates to processes of manufacture and corresponding process products; a container precursor and a closed container, each comprising the planar composite or a blank thereof; a further closed container; and a use of the planar composite or the container precursor.

The present invention relates to a planar composite comprising, as superimposed layers of a layer sequence in the direction from an outer side of the planar composite to an inner side of the planar composite
a. a carrier layer,
b. a barrier layer, and
c. an inner polymer layer:
   wherein the planar composite includes at least a first plurality of grooves arranged and configured such that by folding the planar composite along the grooves of the first plurality of grooves and joining portions of the planar composite, at least a part of a container wall of a closed container is obtainable: wherein the closed container includes a standing base and, in a longitudinal direction, extending along a length of the closed container, opposite to the standing base, a head portion: wherein the head portion includes at least 3 head side surfaces formed of the planar composite, the head side surfaces being inclined to each other in the longitudinal direction such that the closed container tapers at least in sections in the head portion: wherein a perimeter of each of the head side surfaces is respectively formed by a plurality of side edges of the head portion: wherein each of the pluralities of side edges includes a pair of steep edges opposite to each other in a circumferential direction of the closed container perpendicular to the longitudinal direction: wherein each pair of steep edges is formed along a pair of grooves of the first plurality of grooves: wherein the grooves of each of the pairs of grooves lie in a plane of planar extension of the planar composite and, in this plane of planar extension, run at an angle in the range from 40 to 60° to one other. The invention further relates to processes of producing a planar composite, producing a container precursor and producing a closed container, and the corresponding process products: a container precursor and a closed container, each comprising the planar composite or a blank thereof: a further closed container; and a use of the planar composite or the container precursor.

For some time, foodstuffs have been preserved, whether they be foodstuffs for human consumption or else animal feed products, by storing them either in a can or in a jar closed by a lid. In this case, shelf life can be increased firstly by separately and very substantially sterilising the foodstuff and the container in each case, here the jar or can, and then introducing the foodstuff into the container and closing the container. However, these measures of increasing the shelf life of foodstuffs, which have been tried and tested over a long period, have a series of disadvantages, for example the need for another sterilisation later on. Cans and jars, because of their essentially cylindrical shape, have the disadvantage that very dense and space-saving storage is not possible. Moreover, cans and jars have considerable intrinsic weight, which leads to increased energy expenditure in transport. Moreover, production of glass, tinplate or aluminium, even when the raw materials used for the purpose are recycled, necessitates quite a high expenditure of energy. In the case of jars, an aggravating factor is elevated expenditure on transport. The jars are usually prefabricated in a glass factory and then have to be transported to the facility where the foodstuff is dispensed with utilisation of considerable transport volumes. Furthermore, jars and cans can be opened only with considerable expenditure of force or with the aid of tools and hence in a rather laborious manner. In the case of cans, there is a high risk of injury emanating from sharp edges that arise on opening. In the case of jars, it is a repeated occurrence that broken glass gets into the foodstuff in the course of filling or opening of the filled jars, which can lead in the worst case to internal injuries on consumption of the foodstuff. In addition, both cans and jars have to be labelled for identification and promotion of the foodstuff contents. The jars and cans cannot be printed directly with information and promotional messages. In addition to the actual printing, a substrate is thus needed for the purpose, a paper or suitable film, as is a securing means, an adhesive or sealant.

Other packaging systems are known from the prior art, in order to store foodstuffs over a long period with minimum impairment. These are containers made of planar or sheet-like composites, which are often also referred to as laminates. Such laminates are often composed of a thermoplastic layer, a carrier layer often made of cardboard or paper, which gives the container dimensional stability, an adhesion promoter layer, a barrier layer and another plastic layer. Since the carrier layer gives the container made from the laminate dimensional stability, these containers, in contrast to film bags and pouches, are to be seen as a further development of the aforementioned jars and cans.

Although such food containers made of laminates can be produced and filled in the same machine and thus in one production run, there remains a transport effort for supplying the retail trade with the filled containers. To make this transport as efficient as possible, it is desirable to be able to stack as many containers as possible in one pack, i.e., with as little reinforcing transport material as possible. This stackability is limited by the compression stability of the containers, i.e., by the maximum weight that can be placed on a container without its mechanical integrity failing due to compression. In the prior art, this limit often means that existing transport volumes cannot be used efficiently.

In general, it is an object of the present invention to at least partially overcome a disadvantage arising from the prior art.

A further object of the invention is to provide a dimensionally stable foodstuff container made of laminate which, in particular through good stacking behaviour, allows the most efficient utilisation of transport volumes when supplying such foodstuff containers.

Furthermore, it is an object of the invention to provide a dimensionally stable foodstuff container made of laminate, which can be produced in large quantities with as few production interruptions as possible in a filling machine.

A further object of the invention is to provide a dimensionally stable foodstuff container made of laminate which is characterised by an improved shelf life.

According to another object of the invention, one of the above-described advantageous foodstuff containers is particularly suitable for stationary household use, in particular due to its relatively large capacity. According to another object of the invention, one of the above-described advantageous foodstuff containers is particularly suitable for mobile use, especially due to its good grip stiffness.

In accordance with a further object of the invention, one of the advantageous foodstuff containers described above is additionally characterised by good standing stability of the individual container.

A contribution to the at least partial fulfilment of at least one, preferably more than one, of the above objects is provided by the independent claims. The dependent claims provide preferred embodiments that contribute to the at least partial fulfilment of at least one of the objects.

A 1^{st} embodiment of the invention is a planar composite comprising as superimposed layers of a layer sequence in the direction from an outer side of the planar composite to an inner side of the planar composite
a. a carrier layer,
b. a barrier layer, and
c. an inner polymer layer:
   wherein the planar composite comprises at least a first plurality of grooves arranged and configured such that by folding the planar composite along the grooves of the first plurality of grooves and joining portions of the planar composite, at least a part of a container wall of a closed container is obtainable: wherein the closed container includes a standing base and, in a longitudinal direction, extending along a length of the closed container, opposite the standing base, a head portion: wherein the head portion includes at least 3, preferably 3 to 12, more preferably 3 to 10, more preferably 3 to 8, more preferably 3 to 6, still more preferably 3 or 4, most preferably 4, preferably planar, head side surfaces formed from the planar composite, the head side surfaces being inclined to each other in the longitudinal direction such that the closed container tapers at least in sections in the head portion: wherein a perimeter of each of the head side surfaces is respectively formed by a plurality of side edges of the head portion: wherein each of the pluralities of side edges includes a pair of steep edges opposite to each other in a circumferential direction of the closed container perpendicular to the longitudinal direction: wherein each pair of steep edges is formed along a pair of grooves of the first plurality of grooves: wherein the grooves of each of the pairs of grooves lie in a plane of planar extension of the planar composite and, in this plane of planar extension, run at an angle in the range from 40 to 60°, more preferably from 41 to 59°, more preferably from 42 to 58°, more preferably from 43 to 57°, more preferably from 44 to 57°, more preferably from 45 to 57°, more preferably from 46 to 57°, more preferably from 47 to 57°, more preferably from 48 to 57°, more preferably from 49 to 57°, more preferably from 50 to 57°, more preferably from 51 to 57°, more preferably from 52 to 57°, more preferably from 53 to 56°, more preferably from 53.5 to 55.5°, still more preferably from 54.0 to 55.0°, to one other.

Alternatively, preferably, wherein the grooves of each of the pairs of grooves lie in a plane of planar extension of the planar composite and, in this plane of planar extension, run at an angle in the range from 43 to 56°, more preferably from 43 to 55°, more preferably from 43 to 54°, more preferably from 43 to 53°, more preferably from 43 to 52°, more preferably from 43 to 51°, more preferably from 43 to 50°, more preferably from 43 to 49°, more preferably from 43 to 48°, more preferably from 43 to 47°, more preferably from 44.0 to 46.0°, still more preferably from 44.5 to 45.5°, to one other.

Preferably, each of the head side surfaces is substantially trapezoidal. Substantially means here that deviations that do not fundamentally lead away from the basic geometric shape of the trapezoid are possible. In particular, one base side of the trapezoid can be curved.

In a preferred embodiment of the planar composite, at least a part, preferably each, of the pluralities of side edges includes a base edge convexly curved towards the standing base with respect to the head side surface whose perimeter is formed by these side edges. This preferred embodiment is a 2^{nd} embodiment of the invention, which preferably also has the features of the 1^{st} embodiment of the invention.

Preferably, each of the base edges is curved in an arcuate convex shape, more preferably in a circular arcuate convex shape, with respect to the head side surface whose perimeter is formed in part by the respective base edge.

In a preferred embodiment of the planar composite, the head side surfaces together form substantially a lateral surface of a regular truncated pyramid. This preferred embodiment is a 3^{rd} embodiment of the invention, which preferably also has the features of the 1^{st} or 2^{nd} embodiment of the invention.

Substantially means here that deviations that do not fundamentally lead away from the basic geometric shape of the regular truncated pyramid are possible. In particular, the edges of the base surface of the regular truncated pyramid may be curved. Preferably, the edges of the base surface of the regular truncated pyramid, with respect to the adjacent head side surface, are convexly curved, preferably arcuately convexly curved, more preferably circularly arcuately convexly curved. Here, the side edges of each of the head side surfaces preferably consist of the pair of steep edges, an edge of a top surface of the regular truncated pyramid and an edge of a base surface of the regular truncated pyramid. Alternatively or additionally preferred, the angle of the grooves of each of the pairs of grooves is an angle included by the steep edges of each side face of the supplementary pyramid of the regular truncated pyramid at the apex of that supplementary pyramid.

In a preferred embodiment of the planar composite, the regular truncated pyramid has a base surface in the form of a polygon. This preferred embodiment is a 4^{th} embodiment of the invention, which preferably also has the features of the 3^{rd} embodiment of the invention.

A preferred polygon is a regular polygon. Alternatively or additionally preferred, the polygon has 3 to 12, more preferably 3 to 10, more preferably 3 to 8, more preferably 3 to 6, still more preferably 3 or 4, most preferably 4, corners. A preferred polygon with 4 corners is a rectangle. A preferred rectangle is a square. Preferably, the head portion has as many head side faces as the polygon has corners.

In a preferred embodiment of the planar composite, the planar composite is a blank for making a single closed container. This preferred embodiment is a 5^{th} embodiment of the invention, which preferably also has the features of any one of the preceding embodiments of the invention.

Alternatively or additionally preferred, the planar composite includes at least one further plurality of grooves, preferably at least 10 further pluralities of grooves, more preferably at least 50 further pluralities of grooves, each of the further pluralities of grooves having the features of the first plurality of grooves described in the first embodiment. In particular, each further plurality of grooves is arranged and configured such that by folding the planar composite along the grooves of the further plurality of grooves and joining portions of the planar composite, at least a part of a container wall of a further closed container is obtainable.

In a preferred embodiment of the planar composite, the grooves of the at least first plurality of grooves at least partially include linear depressions on the outer surface of the planar composite. This preferred embodiment is a 6^{th} embodiment of the invention, which preferably also has the features of any one of the preceding embodiments of the invention.

A preferred linear depression is a linear material displacement. Preferably, the grooves of the at least first plurality of grooves are formed as linear depressions on the outer side of the planar composite. Further preferably, the grooves of the at least first plurality of grooves have bulges on the inner side of the planar composite.

In a preferred embodiment of the planar composite, the planar composite additionally includes an outer polymer layer: wherein the outer polymer layer superimposes the carrier layer on a side of the carrier layer facing away from the barrier layer. This preferred embodiment is a 7^{th} embodiment of the invention, which preferably also has the features of any of the preceding embodiments of the invention.

In a preferred embodiment, the outer polymer layer is adjacent to the carrier layer. The outer polymer layer preferably comprises at least 50% by weight, preferably at least 60% by weight, more preferably at least 70% by weight, even more preferably at least 80% by weight, most preferably at least 90% by weight, in each case based on the weight of the outer polymer layer, of a polyolefin, preferably a polyethylene or a polypropylene or both.

In a preferred embodiment of the planar composite, the outer polymer layer comprises at least 50% by weight, preferably at least 60% by weight, more preferably at least 70% by weight, even more preferably at least 80% by weight, most preferably at least 90% by weight, each based on the weight of the outer polymer layer, of one or more LDPE. This preferred embodiment is an 8^{th} embodiment of the invention, which preferably also has the features of the 7^{th} embodiment of the invention.

In a preferred embodiment of the planar composite, the outer polymer layer is superimposed with a colour application, preferably a decoration, on a side of the outer polymer layer facing away from the carrier layer or on a side of the outer polymer layer facing the carrier layer. This preferred embodiment is a 9^{th} embodiment of the invention, which preferably also has the features of the 7^{th} or 8^{th} embodiment of the invention.

In both of the above arrangements, the colour application is preferably adjacent to the outer polymer layer. Preferably, the colour application includes at least one colourant, more preferably at least 2, more preferably at least 3, more preferably at least 4, still more preferably at least 5, most preferably at least 6, colourants. The aforementioned colourants preferably each have different colours from one another. A preferred colour application is a printed colour application.

In a preferred embodiment of the planar composite, the planar composite includes an intermediate polymer layer between the carrier layer and the barrier layer. This preferred embodiment is a 10^{th} embodiment of the invention, which preferably also has the features of any of the preceding embodiments of the invention.

In a preferred embodiment of the planar composite, one selected from the group consisting of the inner polymer layer, the intermediate polymer layer and the outer polymer layer, or each layer of a combination of at least two thereof, comprises one or more polyolefins, preferably one or more polyethylenes, and/or one or more polypropylenes. Preferably, the layer consists of the aforementioned polymer or polymers. This preferred embodiment is an 11^{th} embodiment of the invention, which preferably also has the features of any one of the preceding embodiments of the invention.

Preferably, one selected from the group consisting of the inner polymer layer, the intermediate polymer layer and the outer polymer layer, or each layer of a combination of at least two thereof, comprises the polyolefin or polyolefins, preferably the polyethylene or polyethylenes, and/or the polypropylene or polypropylenes, in a proportion of at least 50% by weight, preferably at least 60% by weight, more preferably at least 70% by weight, even more preferably at least 80% by weight, most preferably at least 90% by weight, each based on the weight of the respective layer.

In a preferred embodiment of the planar composite, the carrier layer comprises one selected from the group consisting of cardboard, paperboard, and paper, or a combination of at least two thereof. Preferably, the carrier layer consists thereof. This preferred embodiment is a 12^{th} embodiment of the invention, which preferably also has the features of any of the preceding embodiments of the invention.

The terms “paperboard”, “cardboard” and “paper” are used herein according to the definitions in the standard DIN 6735:2010. In addition, cardboard is preferably a material that has a combination of properties of paper and paperboard. Further, cardboard preferably has a basis weight in a range of 150 to 600 g/m².

In a preferred embodiment of the planar composite, the barrier layer comprises one selected from the group consisting of a plastic, a metal, and a metal oxide, or a combination of at least two thereof. Preferably, the barrier layer consist thereof. This preferred embodiment is a 13^{th} embodiment of the invention, which preferably also has the features of any of the preceding embodiments of the invention.

In a preferred embodiment of the planar composite, the closed container has a capacity in a range from 100 to 2000 ml, preferably from 100 to 1500 ml, more preferably from 100 to 1200 ml, more preferably from 100 to 1000 ml, more preferably from 100 to 900 ml, more preferably from 100 to 800 ml, more preferably from 100 to 700 ml, more preferably from 100 to 600 ml, more preferably from 100 to 500 ml, more preferably from 100 to 480 ml, more preferably from 100 to 460 ml, more preferably from 100 to 440 ml, more preferably from 100 to 420 ml, more preferably from 100 to 400 ml, more preferably from 100 to 380 ml, more preferably from 100 to 360 ml, more preferably from 110 to 360 ml, more preferably from 120 to 360 ml, more preferably from 130 to 360 ml, more preferably from 140 to 360 ml, more preferably from 150 to 360 ml, more preferably from 160 to 360 ml, still more preferably from 170 to 360 ml. This preferred embodiment is a 14^{th} embodiment of the invention, which preferably also has the features of any of the preceding embodiments of the invention.

Further preferably, the closed container has a capacity in a range from 150 to 2000 ml, more preferably from 200 to 2000 ml, more preferably from 250 to 2000 ml, more preferably from 300 to 2000 ml, more preferably from 350 to 2000 ml, more preferably from 400 to 2000 ml, more preferably from 420 to 2000 ml, more preferably from 440 to 2000 ml, more preferably from 460 to 2000 ml, more preferably from 480 to 2000 ml, more preferably from 480 to 1800 ml, more preferably from 480 to 1600 ml, more preferably from 480 to 1400 ml, more preferably from 480 to 1200 ml, most preferably from 480 to 1150 ml, more preferably from 480 to 1100 ml, still more preferably from 490 to 1100 ml.

In a preferred embodiment of the planar composite, the first plurality of grooves includes 4 longitudinal grooves, each longitudinal groove being arranged and configured to obtain a longitudinal edge of the closed container by folding along the respective longitudinal groove, each longitudinal edge of the closed container extending along the length of the closed container from the standing base to the head portion, wherein the closed container has a square cross-section along its length between the standing base and the head portion at least in sections, preferably continuously, wherein the shortest of the 4 longitudinal grooves has a length 1, wherein a ratio of the length 1 to an edge length a of the square cross-section lies in a range from 1.3 to 2.95, preferably from 1.35 to 2.95, more preferably from 1.38 to 2.8, most preferably from 1.39 to 2.8. This preferred embodiment is a 15^{th} embodiment of the invention, which preferably also has the features of any of the preceding embodiments of the invention.

The length 1 is the height of the closed container excluding its head portion. Preferably, the 4 longitudinal grooves are of equal length. In principle, however, it is also possible that, for example, 2 longitudinal grooves are shorter than the other two longitudinal grooves. In this case, the length 1 designates the shorter longitudinal grooves.

A 16^{th} embodiment of the invention is a process comprising as process steps:
a) providing a planar composite precursor comprising a carrier layer; and
b) introducing at least a first plurality of grooves into the planar composite precursor: wherein the grooves of the first plurality of grooves are introduced such that by folding a planar composite obtained from the planar composite precursor along the grooves of the first plurality of grooves and joining portions of the planar composite, at least a part of a container wall of a closed container is obtainable: wherein the closed container includes a standing base and, in a longitudinal direction, extending along a length of the closed container, opposite the standing base, a head portion: wherein the head portion includes at least 3, preferably 4, preferably planar, head side surfaces formed from the planar composite, the head side surfaces being inclined to each other in the longitudinal direction such that the closed container tapers at least in sections in the head portion: wherein a perimeter of each of the head side surfaces is respectively formed by a plurality of side edges of the head portion: wherein each of the pluralities of side edges includes a pair of steep edges opposite to each other in a circumferential direction of the closed container perpendicular to the longitudinal direction: wherein each pair of steep edges is formed along a pair of grooves of the first plurality of grooves: wherein the grooves of each of the pairs of grooves lie in a plane of planar extension of the planar composite and, in this plane of planar extension, run at an angle in the range of from 40 to 60°, more preferably from 41 to 59°, more preferably from 42 to 58°, more preferably from 43 to 57°, more preferably from 44 to 57°, more preferably from 45 to 57°, more preferably from 46 to 57°, more preferably from 47 to 57°, more preferably from 48 to 57°, more preferably from 49 to 57°, more preferably from 50 to 57°, more preferably from 51 to 57°, more preferably from 52 to 57°, more preferably from 53 to 56°, more preferably from 53.5 to 55.5°, still more preferably from 54.0 to 55.0°, to one other.

Preferably, the carrier layer is designed and arranged according to one of the embodiments of the planar composite according to the invention. Alternatively or additionally preferred, the first plurality of grooves is configured and arranged according to one of the embodiments of the planar composite according to the invention. Preferably, the process is a process for producing the planar composite, preferably of producing the planar composite. A preferred planar composite is configured for manufacturing at least one, preferably exactly one, foodstuff container. Alternatively or additionally preferred, the planar composite is formed according to one of the embodiments of the planar composite according to the invention.

In a preferred embodiment of the above process, the process additionally includes as process steps:
c) superimposing the carrier layer with a barrier layer; and
d) superimposing the barrier layer on a side of the barrier layer facing away from the carrier layer with an inner polymer layer, thereby obtaining the planar composite.

This preferred embodiment is a 17^{th} embodiment of the invention, which preferably also has the features of the 16^{th} embodiment of the invention.

Preferably, the barrier layer is designed and arranged according to one of the embodiments of the planar composite according to the invention. The superimposing with the barrier layer preferably takes the form of lamination. Preferably, the inner polymer layer is designed and arranged according to one of the embodiments of the planar composite according to the invention. The superimposing with the inner polymer layer is preferably carried out by extruding an inner polymer composition from which the inner polymer layer is obtainable.

In a preferred embodiment of the process, the carrier layer is superimposed with an outer polymer layer on a side of the carrier layer facing away from the barrier layer between process steps b) and c). This preferred embodiment is an 18^{th} embodiment of the invention, which preferably also has the features of the 17^{th} embodiment of the invention.

Preferably, the outer polymer layer is designed and arranged according to one of the embodiments of the planar composite according to the invention. The superimposing with the outer polymer layer is preferably carried out by extruding an outer polymer composition from which the outer polymer layer is obtainable.

In a preferred embodiment of the process, an intermediate polymer layer is introduced between the carrier layer and the barrier layer in process step c). This preferred embodiment is a 19^{th} embodiment of the invention, which preferably also has the features of the 17^{th} or 18^{th} embodiment of the invention.

Preferably, the intermediate polymer layer is designed and arranged according to one of the embodiments of the planar composite according to the invention. Preferably, the introducing of the intermediate polymer layer is performed by extruding an intermediate polymer composition from which the intermediate polymer layer is obtainable. Preferably, the intermediate polymer composition serves as a laminating agent, in particular for joining the carrier layer to the barrier layer.

In a preferred embodiment of the process, the planar composite precursor in the process step a) comprises, as superimposed layers of a layer sequence in the direction from an outer side of the planar composite precursor to an inner side of the planar composite precursor
A. the carrier layer,
B. a barrier layer, and
C. an inner polymer layer:
   wherein in process step b) the planar composite is obtained. This preferred embodiment is a 20^{th} embodiment of the invention, which preferably also has the features of the 16^{th} embodiment of the invention.

Preferably, the carrier layer, the barrier layer, or the inner polymer layer, or any layer of a combination of at least two of the foregoing is configured and arranged according to one of the embodiments of the planar composite according to the invention.

In a preferred embodiment of the process, the planar composite precursor in process step a) additionally comprises an outer polymer layer superimposing the carrier layer on a side facing the outer side. This preferred embodiment is a 21^{st} embodiment of the invention, which preferably also has the features of the 20^{th} embodiment of the invention.

Preferably, the outer polymer layer is configured and arranged according to one of the embodiments of the planar composite according to the invention.

In a preferred embodiment of the process, the planar composite precursor in process step a) additionally includes an intermediate polymer layer between the carrier layer and the barrier layer. This preferred embodiment is a 22^{nd} embodiment of the invention, which preferably also has the features of the 20^{th} or 21^{st} embodiment of the invention.

Preferably, the intermediate polymer layer is designed and arranged according to one of the embodiments of the planar composite according to the invention.

In a preferred embodiment of the process, the process additionally comprises, after the process step a), separating a blank for producing a single closed container from the planar composite precursor. This preferred embodiment is a 23^{rd} embodiment of the invention, which preferably also has the features of any of the 16^{th} to 22^{nd} embodiments of the invention.

Preferably, the aforementioned separation takes place after process step b). Alternatively or additionally preferred, the aforementioned separation is carried out as cutting or punching or both.

In a preferred embodiment of the process, in the process step b), the introducing of the grooves of the at least first plurality of grooves takes place as an introducing of an at least first plurality of line-shaped depressions on a side of the carrier layer which faces away from the barrier layer in the planar composite. This preferred embodiment is a 24^{th} embodiment of the invention, which preferably also has the features of any of the 16^{th} to 23^{rd} embodiments of the invention.

Preferably, the introducing is performed by contacting the planar composite precursor on the side of the carrier layer facing away from the barrier layer in the planar composite, and preferably simultaneously on an opposite side of the planar composite precursor with at least one grooving tool. In this case, a, preferably linear, region of the planar composite precursor on the aforementioned opposite side is preferably received in a recess in the grooving tool. In doing so, the region is preferably pressed into the recess. Thus, the linear depressions are preferably obtained as linear material displacements. A preferred grooving tool has a multi-part structure. Thus, the grooving tool preferably comprises a part with a recess and another part which is designed for pressing the planar composite precursor into the recess. Accordingly, these two parts are preferably designed to engage with each other.

In a preferred embodiment of the process, the planar composite precursor in process step a) additionally includes a colour application superimposing the outer polymer layer on a side of the outer polymer layer facing away from the carrier layer. This preferred embodiment is a 25^{th} embodiment of the invention, which preferably also has the features of any of the 21^{st} to 24^{th} embodiments of the invention.

Preferably, the colour application is designed and arranged according to one of the embodiments of the planar composite according to the invention.

In a preferred embodiment of the process, the planar composite precursor additionally includes a colour application superimposing the carrier layer. This preferred embodiment is a 26^{th} embodiment of the invention, which preferably also has the features of any of the 16^{th} to 24^{th} embodiments of the invention.

Preferably, the colour application is designed and arranged according to one of the embodiments of the planar composite according to the invention. Preferably, the colour application superimposes the carrier layer on a side of the carrier layer facing away from the barrier layer. Preferably, the colour application is adjacent to the carrier layer.

A 27^{th} embodiment of the invention is a planar composite obtainable by the process according to the invention, preferably according to any of the 16^{th} to 26^{th} embodiments of the invention.

This planar composite is preferably formed like the planar composite according to the invention according to one of its preceding embodiments.

A 28^{th} embodiment of the invention is a container precursor comprising
the planar composite according to the invention, preferably according to one of the 1^{st} to 15^{th}, or 27^{th} embodiments of the invention, or
a blank of this planar composite for producing a closed container.

In a preferred embodiment of the container precursor, the planar composite or blank has at least two folds, preferably at least 3 folds, more preferably at least 4 folds. This preferred embodiment is a 29^{th} embodiment of the invention, which preferably also has the features of the 28^{th} embodiment of the invention.

The aforementioned folds are preferably longitudinal folds.

In a preferred embodiment of the container precursor, the planar composite or blank includes a first longitudinal margin and a further longitudinal margin opposite the first longitudinal margin in the circumferential direction: wherein the first longitudinal margin is joined to the further longitudinal margin to form a longitudinal seam of the container precursor. This preferred embodiment is a 30^{th} embodiment of the invention, which preferably also has the features of the 28^{th} or 29^{th} embodiment of the invention.

A 31^{st} embodiment of the invention is a closed container comprising a container wall surrounding a container interior, the container wall being at least partially formed of
the planar composite according to the invention, preferably according to one of the 1^{st} to 15^{th}, or 27^{th} embodiments of the invention, or
a blank of this planar composite for the manufacture of a closed container.

Preferably, the closed container according to the invention is a foodstuff container.

In a preferred embodiment of the closed container, at least a part of the container wall is obtainable by folding the planar composite or blank along the grooves of the at least first plurality of grooves and joining portions of the planar composite. This preferred embodiment is a 32^{nd} embodiment of the invention, which preferably also has the features of the 31^{st} embodiment of the invention.

A 33^{rd} embodiment of the invention is a closed container comprising a container wall surrounding a container interior, the container wall being formed at least in part of a planar composite: wherein the planar composite comprises, as superimposed layers of a layer sequence, in a direction from an outer side of the planar composite to an inner side of the planar composite:
a. a carrier layer,
b. a barrier layer, and
c. an inner polymer layer;
   wherein the closed container includes a standing base and, in a longitudinal direction, extending along a length of the closed container, opposite the standing base, a head portion: the head portion including at least 3, preferably 4, preferably planar, head side surfaces formed of the planar composite, the head side surfaces being inclined to each other in the longitudinal direction such that the closed container tapers at least in sections in the head portion: wherein a perimeter of each of the head side surfaces is respectively formed by a plurality of side edges of the head portion: wherein each of the plurality of side edges includes a pair of steep edges opposite to each other in a circumferential direction of the closed container perpendicular to the longitudinal direction: wherein the steep edges of each pair of steep edges of each of the head side surfaces lie in a plane of the respective head side surface and, in this plane of the respective head side surface, run at an angle in the range of from 40 to 60°, preferably from 41 to 59°, more preferably from 42 to 58°, more preferably from 43 to 57°, more preferably from 44 to 57°, more preferably from 45 to 57°, more preferably from 46 to 57°, more preferably from 47 to 57°, more preferably from 48 to 57°, more preferably from 49 to 57°, more preferably from 50 to 57°, more preferably from 51 to 57°, more preferably from 52 to 57°, more preferably from 53 to 56°, more preferably from 53.5 to 55.5°, still more preferably from 54.0 to 55.0°, to one other.

Alternatively preferably, the steep edges of each pair of steep edges of each of the head side surfaces lie in a plane of the respective head side surface and, in this plane of the respective head side surface, run at an angle in the range of from 43 to 56°, more preferably from 43 to 55°, more preferably from 43 to 54°, more preferably from 43 to 53°, more preferably from 43 to 52°, more preferably from 43 to 51°, more preferably from 43 to 50°, more preferably from 43 to 49°, more preferably from 43 to 48°, more preferably from 43 to 47°, more preferably from 44.0 to 46.0°, still more preferably from 44.5 to 45.5°, to one other.

Preferably, the carrier layer is designed and arranged according to one of the embodiments of the planar composite according to the invention. Alternatively or additionally preferred, the barrier layer is designed and arranged according to one of the embodiments of the planar composite according to the invention. Alternatively or additionally preferred, the inner polymer layer is designed and arranged according to one of the embodiments of the planar composite according to the invention. Alternatively or additionally preferred, the planar composite is designed according to one of the embodiments of the planar composite according to the invention. Alternatively or additionally preferred, the head portion of the closed container is designed and arranged as described in one of the embodiments of the planar composite according to the invention. Alternatively or additionally preferred, the container wall of the closed container is designed and arranged as described in one of the embodiments of the planar composite according to the invention. Preferably, at least a portion of the container wall is obtainable by folding the planar composite of the invention according to one of the embodiments or a blank thereof along the grooves of the at least first plurality of grooves and joining portions of the planar composite or blank.

In a preferred embodiment of the foregoing closed container, each of the pluralities of side edges includes a base edge which is convexly curved towards the standing base with respect to the head side surface whose perimeter is formed by the side edges. This preferred embodiment is a 34^{th} embodiment of the invention, which preferably also has the features of the 33^{rd} embodiment of the invention.

Preferably, each of the base edges is curved in an arcuate convex shape, more preferably in a circular arcuate convex shape, with respect to the head side surface whose perimeter is formed by the respective base edge.

In a preferred embodiment of the closed container, the head side surfaces together form substantially a lateral surface of a regular truncated pyramid. This preferred embodiment is a 35^{th} embodiment of the invention, which preferably also has the features of the 33^{rd} or 34^{th} embodiment of the invention.

Substantially means here that deviations that do not fundamentally lead away from the basic geometric shape of the regular truncated pyramid are possible. In particular, the edges of the base surface of the regular truncated pyramid may be curved. Preferably, the edges of the base surface of the regular truncated pyramid, with respect to the adjacent head side surface, are convexly curved, preferably arcuately convexly curved, more preferably circularly convexly curved. Here, the side edges of each of the head side surfaces preferably consist of the pair of steep edges, an edge of a top surface of the regular truncated pyramid and an edge of a base surface of the regular truncated pyramid. Alternatively or additionally preferred, the angle of the steep edges of each pair of steep edges is an angle included by the steep edges of each side face of the supplementary pyramid of the regular truncated pyramid at the apex of that supplementary pyramid.

In a preferred embodiment of the closed container, the regular truncated pyramid has a base surface in the form of a polygon. This preferred embodiment is a 36^{th} embodiment of the invention, which preferably also has the features of the 35^{th} embodiment of the invention.

A preferred polygon is a regular polygon. Alternatively or additionally preferred the polygon has 3 to 12, more preferably 3 to 10, more preferably 3 to 8, more preferably 3 to 6, still more preferably 3 or 4, most preferably 4, corners. A preferred polygon with 4 corners is a rectangle. A preferred rectangle is a square. Preferably, the head portion has as many head side faces as the polygon has corners.

In a preferred embodiment of the closed container, a first part of the container wall is formed from the planar composite or blank: wherein a further part of the container wall is formed from an element other than the planar composite or blank. This preferred embodiment is a 37^{th} embodiment of the invention, which preferably also has the features of any of the 31^{st} to 36^{th} embodiments of the invention. Preferably, the first part and the further part together form the container wall so that the container is closed.

In a preferred embodiment of the closed container, the first part of the container wall is an open cup-shaped container. This preferred embodiment is a 38^{th} embodiment of the invention, which preferably also has the features of the 37^{th} embodiment of the invention. Preferably, the element other than the planar composite or the blank closes the open cup-shaped container formed from the first part.

In a preferred embodiment of the closed container, the further part of the container wall is encompassed by the head portion of the closed container. This preferred embodiment is a 39^{th} embodiment of the invention, which preferably also has the features of the 37^{th} or 38^{th} embodiment of the invention.

In a preferred embodiment of the closed container, the element other than the planar composite or the blank bounds the container interior in the longitudinal direction. This preferred embodiment is a 40^{th} embodiment of the invention, which preferably also has the features of any one of the 37^{th} to 39^{th} embodiments of the invention.

Preferably, the element other than the planar composite or the blank forms a top surface of the head portion of the closed container. A preferred top surface is the top surface of a regular truncated pyramid.

In a preferred embodiment of the closed container, the element other than the planar composite or the blank is a non-planar component. This preferred embodiment is a 41^{st} embodiment of the invention, which preferably also has the features of any one of the 37^{th} to 40^{th} embodiments of the invention.

A preferred non-planar component comprises a first polymer composition. Preferably, the non-planar component consists of the first polymer composition. A preferred first polymer composition comprises a polyolefin or a polycondensate or both. Preferably, the first polymer composition comprises the polyolefin or the polycondensate or both together in a proportion in a range of from 70 to 100% by weight, preferably from 80 to 99% by weight, more preferably from 90 to 98% by weight, each based on the first polymer composition. A preferred polycondensate is a polyester or polyamide (PA) or both. A preferred polyester is a polyethylene terephthalate (PET). A preferred polyolefin is a polyethylene or a polypropylene or both. A preferred polyethylene is an HDPE. A preferred first polymer composition additionally comprises a colourant. Preferably, the first polymer composition comprises the colourant in a proportion in a range from 0.5 to 5% by weight, preferably from 0.5 to 4% by weight, more preferably from 0.5 to 3% by weight, in each case based on the first polymer composition. A preferred first polymer composition has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 100 to 180° C., more preferably from 100 to 170° C., more preferably from 100 to 160° C., more preferably from 110 to 150° C., more preferably from 120 to 140° C., still more preferably from 125 to 140° C., most preferably from 128 to 136° C.

In a preferred embodiment of the closed container, the element other than the planar composite or the blank includes a spout. This preferred embodiment is a 42^{nd} embodiment of the invention, which preferably also has the features of any one of the 37^{th} to 41^{st} embodiments of the invention.

Preferably, a cap, preferably a screw cap, is arranged at the element other than the planar composite or the blank in such a way that a pouring aperture of the spout is covered with the cap. Preferably, the cap is screwed onto the spout.

A preferred cap includes a second polymer composition. Preferably, the cap consists of the second polymer composition. Preferably, the second polymer composition comprises a polyolefin or a polycondensate or both. Preferably, the second polymer composition comprises the polyolefin or the polycondensate or both together in a proportion in a range of from 70 to 100% by weight, preferably from 80 to 99% by weight, more preferably from 90 to 98% by weight, each based on the second polymer composition. A preferred polyolefin is a polyethylene or a polypropylene or both. A preferred polyethylene is an HDPE. A preferred polycondensate is a polyester or polyamide (PA) or both. A preferred polyester is a polyethylene terephthalate (PET). A preferred second polymer composition additionally comprises a colourant. A preferred second polymer composition additionally comprises a colourant. The second polymer composition preferably has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 100 to 180° C., more preferably from 100 to 170° C., more preferably from 100 to 160° C., more preferably from 110 to 150° C., more preferably from 120 to 140° C., still more preferably from 125 to 140° C., most preferably from 128 to 136° C.

In a further preferred embodiment of the closed container, an opening aid is arranged on the element other than the planar composite or the blank, preferably in the spout. This preferred embodiment is a 43^{rd} embodiment of the invention, which preferably also has the features of any one of the 37^{th} to 42^{nd} embodiments of the invention. Alternatively or additionally preferred, the opening aid is arranged at the cap, preferably in the cap. Preferably, the opening aid is designed and arranged for opening a pouring aperture of the spout.

A preferred opening aid is a cutting aid or a tearing aid or both. Alternatively or additionally preferred, the opening aid is ring-shaped. A preferred ring-shaped cutting aid is a cutting ring. A preferred ring-shaped tear aid is a tear ring.

A preferred opening aid comprises a third polymer composition. Preferably, the opening aid consists of the third polymer composition. Preferably, the third polymer composition comprises a polyolefin or a polycondensate or both. Preferably, the third polymer composition comprises the polyolefin or the polycondensate or both together in a proportion in a range from 50 to 100% by weight, more preferably from 60 to 100% by weight, more preferably from 70 to 100% by weight, even more preferably from 80 to 100% by weight, most preferably from 90 to 100% by weight, each based on the third polymer composition. A preferred polyolefin is a polyethylene or a polypropylene or both. A preferred polyethylene is an HDPE. A preferred polycondensate is a polyester or polyamide (PA) or both. A preferred polyester is a polyethylene terephthalate (PET). A preferred third polymer composition additionally includes a colourant. The third polymer composition preferably has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 110 to 180° C., most preferably from 120 to 170° C.

In a further preferred embodiment of the closed container, the closed container contains a foodstuff. This preferred embodiment is a 44^{th} embodiment of the invention, which preferably also has the features of any one of the 31^{st} to 43^{rd} embodiments of the invention.

In a further preferred embodiment of the closed container, the planar composite or the blank has at least two folds, preferably at least 3 folds, more preferably at least 4 folds. This preferred embodiment is a 45^{th} embodiment of the invention, which preferably also has the features of any one of the 31^{st} to 44^{th} embodiments of the invention.

In a further preferred embodiment of the closed container, the planar composite or the blank includes a first longitudinal margin and a further longitudinal margin opposite the first longitudinal margin in the circumferential direction: the first longitudinal margin being joined to the further longitudinal margin to form a longitudinal seam of the closed container. This preferred embodiment is a 46^{th} embodiment of the invention, which preferably also has the features of any one of the 31^{st} to 45^{th} embodiments of the invention.

In a further preferred embodiment of the closed container, the container interior has a capacity in a range from 100 to 2000 ml, preferably from 100 to 1500 ml, more preferably from 100 to 1200 ml, more preferably from 100 to 1000 ml, more preferably from 100 to 900 ml, more preferably from 100 to 800 ml, more preferably from 100 to 700 ml, more preferably from 100 to 600 ml, more preferably from 100 to 500 ml, more preferably from 100 to 480 ml, more preferably from 100 to 460 ml, more preferably from 100 to 440 ml, more preferably from 100 to 420 ml, more preferably from 100 to 400 ml, more preferably from 100 to 380 ml, more preferably from 100 to 360 ml, more preferably from 110 to 360 ml, more preferably from 120 to 360 ml, more preferably from 130 to 360 ml, more preferably from 140 to 360 ml, more preferably from 150 to 360 ml, more preferably from 160 to 360 ml, still more preferably from 170 to 360 ml. This preferred embodiment is a 47^{th} embodiment of the invention, which preferably also has the features of any one of the 31^{st} to 46^{th} embodiments of the invention.

Further preferably, the container interior has a capacity in a range from 150 to 2000 ml, more preferably from 200 to 2000 ml, more preferably from 250 to 2000 ml, more preferably from 300 to 2000 ml, more preferably from 350 to 2000 ml, more preferably from 400 to 2000 ml, more preferably from 420 to 2000 ml, more preferably from 440 to 2000 ml, more preferably from 460 to 2000 ml, more preferably from 480 to 2000 ml, more preferably from 480 to 1800 ml, more preferably from 480 to 1600 ml, more preferably from 480 to 1400 ml, more preferably from 480 to 1200 ml, most preferably from 480 to 1150 ml, more preferably from 480 to 1100 ml, still more preferably from 490 to 1100 ml.

In a further preferred embodiment, the closed container has 4 longitudinal edges, each longitudinal edge of the closed container running along the length of the closed container from the standing base to the head portion, wherein the closed container has a square cross-section at least in sections, preferably continuously, along its length between the standing base and the head portion, wherein the shortest of the 4 longitudinal edges has a length 1, wherein a ratio of the length 1 to an edge length a of the square cross-section is in a range from 1.3 to 2.95, preferably from 1.35 to 2.95, more preferably from 1.38 to 2.8, most preferably from 1.39 to 2.8. This preferred embodiment is a 48^{th} embodiment of the invention, which preferably also has the features of any one of the 31^{st} to 47^{th} embodiments of the invention.

The length 1 is the height of the closed container excluding its head portion. Preferably, the 4 longitudinal edges are of equal length. In principle, however, it is also possible that, for example, 2 longitudinal edges are shorter than the other 2 longitudinal edges. In this case, the length 1 designates the shorter longitudinal edges.

A 49^{th} embodiment of the invention is a process, comprising as process steps
a. providing the planar composite according to the invention, preferably according to any one of the 1^{st} to 15^{th}, or 27^{th} embodiments of the invention, or a blank of this planar composite for producing a closed container, the planar composite or the blank comprising a first longitudinal margin and a further longitudinal margin;
b. folding the planar composite or the blank along grooves of the at least first plurality of grooves; and
c. contacting and joining the first longitudinal margin with the further longitudinal margin to obtain a longitudinal seam.

The further longitudinal margin is preferably opposite the first longitudinal margin in the circumferential direction. The process preferably is a process for producing a container precursor, preferably a process of producing a container precursor. The container precursor preferably is the container precursor of the invention according to any one of its embodiments.

A 50^{th} embodiment of the invention is a container precursor obtainable by the above process of the 49^{th} embodiment of the invention. This container precursor is preferably designed like the container precursor according to the invention according to any one of its embodiments.

A 51^{st} embodiment of the invention is a process, comprising as process steps
A) providing the container precursor according to the invention, preferably according to any one of the 28^{th} to 30^{th}, or 50^{th} embodiments of the invention;
B) forming and closing a head portion of the container precursor;
C) filling the container precursor with a foodstuff; and
D) forming and closing a standing base of the container precursor by folding the planar composite or the blank along grooves of the at least first plurality of grooves and joining portions of the planar composite or the blank to one another to obtain a closed container.

The process preferably is a process for producing a closed container, preferably a process of producing a closed container. The closed container preferably is the closed container of the invention according to any one of its embodiments.

In a preferred embodiment of the foregoing process, the head portion includes at least 3, preferably 3 to 12, more preferably 3 to 10, more preferably 3 to 8, more preferably 3 to 6, even more preferably 3 or 4, most preferably 4, head side surfaces formed from the planar composite or the blank, which are preferably planar, and which are inclined relative to one another in a longitudinal direction, extending along a length of the container precursor, such that the container precursor tapers in the head portion at least in sections: wherein a perimeter of each of the head side surfaces is respectively formed by a plurality of side edges of the head portion: wherein each of the pluralities of side edges includes a pair of steep edges opposite to each other in a circumferential direction of the container precursor perpendicular to the longitudinal direction: wherein the steep edges of each pair of steep edges of each of the head side surfaces lie in a plane of the respective head side surface and, in this plane of the respective head side surface, run at an angle in the range of from 40 to 60°, preferably from 41 to 59°, more preferably from 42 to 58°, more preferably from 43 to 57°, more preferably from 44 to 57°, more preferably from 45 to 57°, more preferably from 46 to 57°, more preferably from 47 to 57°, more preferably from 48 to 57°, more preferably from 49 to 57°, more preferably from 50 to 57°, more preferably from 51 to 57°, more preferably from 52 to 57°, more preferably from 53 to 56°, more preferably from 53.5 to 55.5°, still more preferably from 54.0 to 55.0°, to one other. This preferred embodiment is a 52^{nd} embodiment of the invention, which preferably also has the features of the 51^{st} embodiment of the invention.

Alternatively preferably, the steep edges of each pair of steep edges of each of the head side surfaces lie in a plane of the respective head side surface and, in this plane of the respective head side surface, run at an angle in the range of from 43 to 56°, more preferably from 43 to 55°, more preferably from 43 to 54°, more preferably from 43 to 53°, more preferably from 43 to 52°, more preferably from 43 to 51°, more preferably from 43 to 50°, more preferably from 43 to 49°, more preferably from 43 to 48°, more preferably from 43 to 47°, more preferably from 44.0 to 46.0°, still more preferably from 44.5 to 45.5°, to one other.

In a further preferred embodiment of the process, each of the pluralities of side edges includes a base edge which is convexly curved towards the standing base in the closed container, relative to the head side surface whose perimeter is formed by these side edges. This preferred embodiment is a 53^{rd} embodiment of the invention, which preferably also has the features of the 52^{nd} embodiment of the invention.

Preferably, each of the base edges is curved in an arcuate convex shape, more preferably in a circular arcuate convex shape, with respect to the head side surface whose circumference is formed by the respective base edge.

In a further preferred embodiment of the process, the head side surfaces together form substantially a lateral surface of a regular truncated pyramid. This preferred embodiment is a 54^{th} embodiment of the invention, which preferably also has the features of the 52^{nd} or 53^{rd} embodiment of the invention.

Substantially means here that deviations that do not fundamentally lead away from the basic geometric shape of the regular truncated pyramid are possible. In particular, the edges of the base surface of the regular truncated pyramid can be curved. Preferably, the edges of the base surface of the regular truncated pyramid, with respect to the adjacent head side surface, are convexly curved, preferably arcuately convexly curved, more preferably circularly convexly curved. Here, the side edges of each of the head side surfaces preferably consist of the pair of steep edges, an edge of a top surface of the regular truncated pyramid and an edge of a base surface of the regular truncated pyramid. Alternatively or additionally preferred, the angle of the steep edges of each pair of steep edges is an angle included by the steep edges of each side face of the supplementary pyramid of the regular truncated pyramid at the apex of that supplementary pyramid.

In a further preferred embodiment of the process, the regular truncated pyramid has a base surface in the form of a polygon. This preferred embodiment is a 55^{th} embodiment of the invention, which preferably also has the features of the 54^{th} embodiment of the invention.

A preferred polygon is a regular polygon. Alternatively or additionally preferred the polygon has 3 to 12, more preferably 3 to 10, more preferably 3 to 8, more preferably 3 to 6, still more preferably 3 or 4, most preferably 4, corners. A preferred polygon with 4 corners is a rectangle. A preferred rectangle is a square. Preferably, the head portion has as many head side faces as the polygon has corners.

In a preferred embodiment of the process, forming and closing the head portion in the process step B) comprises joining the planar composite or the blank to an element other than the planar composite or the blank. This preferred embodiment is a 56^{th} embodiment of the invention, which preferably also has the features of any one of the 51^{st} to 55^{th} embodiments of the invention.

Additionally or alternatively preferred, the joining in the method step B) is performed as a gluing or a sealing or both. A preferred sealing is a heat sealing or an ultrasonic sealing or both. A preferred heat sealing involves heating the planar composite or the blank, or the element other than the planar composite or the blank, or both by contact with a solid or a gas or both. Additionally or alternatively preferred, part of the planar composite or the blank, or part of the element other than the planar composite or the blank, or both is heated to a temperature in the range from 220 to 420° C., preferably from 240 to 400° C., more preferably from 260 to 380° C., in the process step B).

Preferably, the element other than the planar composite or the blank forms a top surface of the head portion of the container precursor. A preferred top surface is the top surface of a regular truncated pyramid.

In a preferred embodiment of the process, the element other than the planar composite or the blank includes a spout. This preferred embodiment is a 57^{th} embodiment of the invention, which preferably also has the features of the 56^{th} embodiment of the invention.

Preferably, a cap, preferably a screw cap, is arranged at the element other than the planar composite or the blank in such a way that a pouring aperture of the spout is covered with the cap. Preferably, the cap is screwed onto the spout. A preferred cap is arranged and/or formed like the cap in one of the embodiments of the closed container according to the invention.

In a further preferred embodiment of the process, an opening aid is arranged at the element other than the planar composite or the blank, preferably in the spout. This preferred embodiment is a 58^{th} embodiment of the invention, which preferably also has the features of the 57^{th} embodiment of the invention. A preferred opening aid is arranged and/or formed like the opening aid in one of the embodiments of the closed container according to the invention.

In a further preferred embodiment of the process, the element other than the planar composite or the blank is a non-planar component. This preferred embodiment is a 59^{th} embodiment of the invention, which preferably also has the features of any one of the 56^{th} to 58^{th} embodiments of the invention. A preferred non-planar component is arranged and/or formed like the non-planar component in one of the embodiments of the closed container according to the invention.

In a further preferred embodiment of the process the joining of the planar composite or the blank to the element other than the planar composite or the blank in the process step B) comprises pressing the planar composite or the blank and the element other than the planar composite or the blank to each other in a first pressing step at a first contact pressure and in a further pressing step at a further contact pressure: wherein the first contact pressure is less than the further contact pressure, preferably by at least 100 mbar, more preferably by at least 200 mbar, more preferably by at least 300 mbar, more preferably by at least 400 mbar, more preferably by at least 500 mbar, more preferably by at least 600 mbar, more preferably by at least 700 mbar, more preferably by at least 800 mbar, even more preferably by at least 900 mbar, most preferably by at least 1,000 mbar. This preferred embodiment is a 60^{th} embodiment of the invention, that preferably depends on any one of the 56^{th} to 59^{th} embodiments of the invention.

Preferably, the first pressing step is conducted prior to the further pressing step. Alternatively, the first pressing step is conducted after the further pressing step. Alternatively, the first pressing step is conducted in temporal overlap with the further pressing step or simultaneously to the further pressing step. Additionally or alternatively preferred, the first pressing step includes pressing in one or two first pressing directions and the further pressing step includes pressing in one or two further pressing directions which are different from the first pressing directions. In the case of two first pressing directions, these are preferably opposite to one another. In the case of two further pressing directions, these are preferably opposite to one another. Preferably, each first pressing direction is substantially perpendicular to each further pressing direction. Additionally or alternatively preferred, the first contact pressure is in the range from 800 to 3,000 mbar, preferably from 1,000 to 2,800 mbar, more preferably from 1,200 to 2,600 mbar. Additionally or alternatively preferred, the further contact pressure is in the range from 2,000 to 4,000 mbar, preferably from 2,200 to 3,800 mbar, more preferably from 2,400 to 3,600 mbar. Additionally or alternatively preferred, in the first pressing step, the planar composite or the blank and the element other than the planar composite or the blank are pressed to each other on a first pair of opposite sides of the element other than the planar composite or the blank. Here, preferably, none of the sides of the first pair of opposite sides of the element other than the planar composite or the blank is pressed to a longitudinal seam of the container precursor in the first pressing step at the first contact pressure. Additionally or alternatively preferred, in the first pressing step, the planar composite or the blank is pressed to 2 side walls of the base member, which are opposite to one another. Additionally or alternatively preferred, in the further pressing step, the planar composite or the blank and the element other than the planar composite or the blank are pressed to each other on a further pair of opposite sides of the element other than the planar composite or the blank. The sides of the further pair of opposite sides are different from the sides of the first pair of opposite sides. Preferably, in the further pressing step the element other than the planar composite or the blank is pressed to a longitudinal seam of the container precursor at the further contact pressure. Additionally or alternatively preferred, in the further pressing step, the blank is pressed to 2 side walls of the base member, which are opposite to one another.

In a further preferred embodiment of the process, the closed container has 4 longitudinal edges, each longitudinal edge of the closed container running along the length of the closed container from the standing base to the head portion, wherein the closed container has a square cross-section at least in sections, preferably continuously, along its length between the standing base and the head portion, wherein the shortest of the 4 longitudinal edges has a length 1, wherein a ratio of the length 1 to an edge length a of the square cross-section is in a range from 1.3 to 2.95, preferably from 1.35 to 2.95, more preferably from 1.38 to 2.8, most preferably from 1.39 to 2.8.

This preferred embodiment is a 61^{st} embodiment of the invention, which preferably also has the features of any one of the 51^{st} to 60^{th} embodiments of the invention.

The length 1 is the height of the closed container excluding its head portion. Preferably, the 4 longitudinal edges are of equal length. In principle, however, it is also possible that, for example, 2 longitudinal edges are shorter than the other 2 longitudinal edges. In this case, the length 1 designates the shorter longitudinal edges.

A 62^{nd} embodiment of the invention is a closed container obtainable by the above process according to the invention, preferably according to any one of the 51^{st} to 61^{st} embodiments of the invention. This closed container is preferably designed like the closed container according to the invention according to any one of its embodiments.

A 63^{rd} embodiment of the invention is a use of the planar composite according to the invention, preferably according to any one of the 1^{st} to 15^{th}, or 27^{th} embodiments of the invention, or of the container precursor according to the invention, preferably according to any one of the 28^{th} to 30^{th}, or 50^{th} embodiments of the invention, in each case for producing a foodstuff container. Preferably, the foodstuff container is one selected from the group consisting of dimensionally stable, closed, and liquid-tight, or a combination of at least two thereof.

Features described as preferred in one category of the invention, for example, according to the planar composite of the invention, are equally preferred in one embodiment of the other categories of the invention, for example, one embodiment of the closed container of the invention or the processes of the invention. Furthermore, the features described below are preferred in connection with each category of the invention.

### Planar Composites

All laminates, in particular sheet-like laminates, which are conceivable within the context of the invention and which appear to the person skilled in the art to be suitable in the context of the invention for the production of dimensionally stable foodstuff containers are to be considered as planar composites. Planar composites for the manufacture of foodstuff containers are also referred to as laminates. Such planar composites have a sequence of layers superimposing each other in a planar manner. The planar composites are often composed of a thermoplastic polymer layer, referred to herein as the outer polymer layer, a carrier layer, often made of cardboard or paper, which gives the container its dimensional stability, an optional thermoplastic polymer layer, referred to herein as the intermediate polymer layer and/or an optional adhesion promoter layer, a barrier layer and a further thermoplastic polymer layer, referred to herein as the inner polymer layer.

Basically, “planar composite” is used herein as a generic term that includes both semi-endless roll material and a blank of such roll material. The blank is preferably designed to produce a single container. Accordingly, the blank has the first plurality of grooves. The roll material as a planar composite has the first plurality of grooves and further pluralities of grooves, i.e. multiple pluralities of grooves. The planar composite can be a flat or three-dimensional object. The latter is, in particular the case, if the planar composite has been folded or rolled up. In any case, the planar composite is sheet-like. Therefore, the planar composite may also be referred to as sheet-like composite.

The layers of the planar composite that form the layer sequence are joined to each other over their entire surface. Two layers are joined together when their adhesion to each other exceeds Van der Waals forces of attraction. Preferably, layers joined with one another are one selected from the group consisting of joined with one another by coating, laminated together, sealed together, glued together, and pressed together, or a combination of at least two thereof. Layers joined with one another by coating are preferably joined with one another by melt coating or by vapour deposition. A preferred melt coating is a melt extrusion coating.

Unless otherwise specified, in a layer sequence the layers may follow each other indirectly, i.e. with one or at least two intermediate layers, or directly, i.e. without an intermediate layer. This is particularly the case in the formulation in which one layer superimposes another layer. A formulation in which a sequence of layers includes enumerated layers means that at least the specified layers are present in the specified order. This formulation does not necessarily mean that these layers immediately follow each other. A formulation in which two layers are adjacent to each other means that these two layers follow each other immediately and thus without an intermediate layer. However, this formulation does not say anything about whether the two layers are joined or not. Rather, these two layers may be in contact with each other. Preferably, however, these two layers are joined with one another, preferably in a planar manner.

In a preferred embodiment of the invention, the planar composite is configured according to one of its embodiments, wherein the planar composite is configured as a blank for producing a closed container: wherein a bending stiffness of the planar composite for bending in a first composite direction is greater than for bending in a further composite direction perpendicular to the first composite direction: wherein the blank includes a first transverse margin and a further transverse margin opposite to the first transverse margin along a longitudinal direction of the closed container; the further transverse margin being arranged and configured to provide a first part of the head portion of the closed container by folding the further transverse margin along grooves of the first plurality of grooves and joining portions of the further transverse margin to one another: wherein an edge of the further transverse margin surrounds a further part of the head portion: the edge extending along at least 50%, preferably at least 60%, more preferably at least 70%, more preferably at least 80%, more preferably at least 90%, still more preferably at least 95%, most preferably 100%, of its length at an angle in an angular range of +30°, preferably of #25°, more preferably of +20°, more preferably of #15°, more preferably of +10°, more preferably of +5°, still more preferably of +3°, most preferably of 0°, about the first composite direction. The edge of the further transverse margin concerned here is preferably a cut edge of the blank. The cut edge is to be distinguished from an edge formed by a fold. Preferably, the first part of the head portion has an opening surrounded by the edge. Preferably, the edge forms a perimeter of the opening. In the closed container, the opening is preferably closed by the further part of the head portion. Generally, the first composite direction as well as the further composite direction lie in a plane of planar extension of the planar composite.

In a further preferred embodiment of the invention, the carrier layer comprises a plurality of fibres; wherein the plurality of fibres has an orientation in the first composite direction. Alternatively or additionally preferred, a length of at least 55% of the fibres of the plurality of fibres extends in an angular range of ±30°, more preferably ±25°, more preferably ±20°, more preferably ±15°, more preferably ±10°, more preferably ±5°, still more preferably #3°, most preferably 0°, about the first composite direction.

In a further preferred embodiment of the invention, the bending stiffness of the planar composite, with respect to a direction of bending of the planar composite, has a maximum for bending in the first composite direction.

In a further preferred embodiment of the invention, the planar composite has a first bending stiffness for bending in the first composite direction and a further bending stiffness for bending in the further composite direction. Preferably, a ratio of the further bending stiffness to the first bending stiffness is in a range from 1:10 to 1:1.5 preferably from 1:9 to 1:1.5, more preferably from 1:8 to 1:1.5, more preferably from 1:7 to 1:1.5, more preferably from 1:6 to 1:1.5, even more preferably from 1:5 to 1:1.5, most preferably from 1:5 to 1:2. Alternatively or additionally preferred, the first bending stiffness is greater than the further bending stiffness by at least 10 mN, more preferably by at least 20 mN, more preferably by at least 30 mN, more preferably by at least 40 mN, more preferably by at least 50 mN, more preferably by at least 60 mN, more preferably by at least 70 mN, more preferably by at least 80 mN, more preferably by at least 90 mN, still more preferably by at least 100 mN, most preferably by at least 150 mN.

Alternatively or additionally preferred, the first bending stiffness is in the range from 50 to 800 mN, more preferably from 50 to 750 mN. Alternatively preferred, the first bending stiffness is in the range from 60 to 800 mN, more preferably from 70 to 800 mN, more preferably from 80 to 800 mN, more preferably from 90 to 800 mN, more preferably from 100 to 800 mN, most preferably from 100 to 750 mN. Alternatively or additionally preferred, the further bending stiffness is in the range from 50 to 750 mN, more preferably from 100 to 700 mN.

In a further preferred embodiment of the invention, the planar composite is configured as a blank for producing a closed container: wherein the blank includes a first transverse margin and a further transverse margin opposite to the first transverse margin along a longitudinal direction of the closed container: wherein the first transverse margin is arranged and configured to provide, by folding the first transverse margin along grooves of the plurality of grooves and joining portions of the first transverse margin, a standing base of the closed container opposite the head portion with respect to the longitudinal direction of the closed container.

In a further preferred embodiment of the invention, the plurality of grooves comprises at least one auxiliary groove, preferably at least 2 auxiliary grooves, more preferably at least 3 auxiliary grooves, most preferably 4 auxiliary grooves: wherein each auxiliary groove is arranged next to a longitudinal groove of the plurality of grooves in the first transverse margin such that a bending radius of a longitudinal fold along this longitudinal groove is increased at least in sections of the longitudinal fold. Preferably, each auxiliary groove curves away from the respective longitudinal groove. Additionally or alternatively preferred, each auxiliary groove is arranged on a side of the respective longitudinal groove which faces away from a centre of the blank, based on a circumferential direction of the closed container which is perpendicular to the longitudinal direction of the closed container.

In a further preferred embodiment of the invention, the head portion includes at least 3, preferably from 3 to 12, more preferably from 3 to 10, more preferably from 3 to 8, more preferably from 3 to 6, still more preferably 3 or 4, most preferably 4, preferably planar, head side surfaces formed from the planar composite or blank, wherein the head side surfaces are inclined to each other in the longitudinal direction of the closed container, such that each of the head side surfaces is at an angle in a range from 55 to 70°, preferably from 55 to 69°, more preferably from 55 to 68°, more preferably from 55 to 67°, more preferably from 55 to 66°, more preferably from 55 to 65°, more preferably from 55 to 64°, more preferably from 56 to 63°, more preferably from 57 to 62°, more preferably from 58 to 61°, still more preferably from 58.5 to 60.0°, to the longitudinal direction. Alternatively preferably the preceding angle is in a range from 56 to 70°, more preferably from 57 to 70°, more preferably from 58 to 70°, more preferably from 59 to 70°, more preferably from 60 to 70°, more preferably from 61 to 70°, more preferably from 62 to 69°, more preferably from 63 to 68°, more preferably from 64 to 67°, still more preferably from 65.0 to 66.0°.

### Outer Side

The outer side of the planar composite is a surface of the planar composite which is intended to be in contact with the environment of the container in a container to be made from the planar composite. This is not precluded by the fact that in individual areas of the container, the outer surfaces of different areas of the composite are folded on top of each other or joined to each other, for example sealed to each other.

### Inner Side

The inner side of the planar composite is a surface of the planar composite which is intended to be in contact with the contents of the container, preferably a foodstuff, in a container to be made from the planar composite.

In the context of the invention, a groove, is a linear material modification intended to facilitate folding of the planar composite or blank along the groove. In particular, the groove is intended to allow a fold to be produced as precisely as possible along the groove. Accordingly, a closed container can be formed from a planar composite or blank having a corresponding groove pattern consisting of grooves by folding along the grooves. This groove pattern is also referred to herein as the first plurality of grooves. The planar composite may include further pluralities of grooves, each of which is arranged and configured to form a respective further container. Preferably, the first plurality of grooves and each further plurality of grooves are identical.

Along the groove, the planar composite preferably has a depression, preferably in the form of a material displacement, on one side, preferably its outer side. On the opposite side, preferably the inner side, the planar composite preferably has a bulge along the groove.

In addition to the aforementioned folding, the production of the closed container includes the joining of areas of the planar composite or blank that have been contacted by way of the folding. Grooving tools are used to introduce the grooves into the planar composite or blank, a process known as grooving. A grooving tool in the context of the invention may be any tool suitable for grooving a planar composite, a blank or a carrier layer. For grooving, the grooving tool preferably includes a linear elevation which has a shape of the linear depression. By contacting the planar composite, blank or carrier layer with the linear elevation, the linear depression can be introduced into the planar composite, blank or carrier layer. Thus, the grooving tool can also be referred to as a pressing tool. As a counterpart to the aforementioned positive tool, the grooving tool may also include a negative tool. The negative tool includes a linear recess, which may also be referred to as groove-shaped. The linear recess preferably has, in a direction of its linear extension, the shape of the linear elevation of the positive tool and is further configured to at least partially receive material of the planar composite, blank or carrier layer displaced by the positive tool during grooving.

### Polymer Layers

In the following, the term “polymer layer” refers in particular to the inner polymer layer, the intermediate polymer layer and the outer polymer layer. The polymer layers are each based on a polymer or a polymer blend, i.e., the polymer layers comprise a majority of the polymer or polymer blend. A preferred polymer is a thermoplastic polymer, more preferably a polyolefin. The polymer layers are preferably incorporated or applied into the planar composite material in an extrusion process, preferably by melt extrusion coating. In addition to the polymer or polymer blend, each polymer layer may comprise further components. The further constituents of the polymer layers are preferably constituents which do not adversely affect the behaviour of the polymer melt when applied as a layer. The further constituents may be, for example, inorganic compounds, such as metal salts, or further plastics, such as further thermoplastics.

In general, suitable polymers for the polymer layers are in particular those which are easy to process due to good extrusion behaviour. Among these, polymers obtained by chain polymerisation are suitable, in particular polyolefins, whereby cyclic olefin co-polymers (COC), polycyclic olefin co-polymers (POC), in particular polyethylene and polypropylene, are particularly preferred and polyethylene is especially preferred. Among the polyethylenes, HDPE (high density polyethylene), MDPE (medium density polyethylene), LDPE (low density polyethylene), LLDPE (linear low density polyethylene) and VLDPE (very low density polyethylene) as well as blends of at least two of them are preferred. Suitable polymers, preferably, have a melt flow rate (MFR) in a range from 1 to 25 g/10 min, preferably in a range from 2 to 20 g/10 min and particularly preferably in a range from 2.5 to 15 g/10 min. Additionally or alternatively preferred, suitable polymer layers have a density in a range of 0.890 g/cm³ to 0.980 g/cm³, preferably in a range of 0.895 g/cm³ to 0.975 g/cm³, and more preferably in a range of 0.900 g/cm³ to 0.970 g/cm³. The polymer layers preferably have at least one melting temperature in a range from 80 to 155° C., preferably in a range from 90 to 145° C., and more preferably in a range from 95 to 135° C.

### Inner Polymer Layer

The inner polymer layer is based on at least one thermoplastic polymer, wherein the inner polymer layer may comprise a particulate inorganic solid. However, it is preferred that the inner polymer layer comprises at least 70% by weight, preferably at least 80% by weight and particularly preferably at least 95% by weight, in each case based on the total weight of the inner polymer layer, of one or more thermoplastic polymers. Preferably, the polymer or polymer blend of the inner polymer layer has a density (according to ISO 1183-1:2004) in a range from 0.900 to 0.980 g/cm³, more preferably in a range from 0.900 to 0.960 g/cm³ and most preferably in a range from 0.900 to 0.940 g/cm³. Preferably, the polymer is a polyolefin. Preferably, the inner polymer layer comprises a polyethylene or a polypropylene or both. Here, a particularly preferred polyethylene is an LDPE.

Preferably, the inner polymer layer comprises the polyethylene or the polypropylene or both together in a proportion of at least 30% by weight, more preferably at least 40% by weight, most preferably at least 50% by weight, each based on the total weight of the inner polymer layer. Additionally or alternatively, the inner polymer layer preferably comprises an HDPE, preferably in an amount of at least 5% by weight, more preferably at least 10% by weight, more preferably at least 15% by weight, most preferably at least 20% by weight, each based on the total weight of the inner polymer layer. In addition or alternatively to one or more of the aforementioned polymers, the inner polymer layer preferably comprises a polymer produced by means of a metallocene catalyst, preferably an mPE. Preferably, the inner polymer layer comprises the mPE in a proportion of at least 3% by weight, more preferably at least 5% by weight, in each case based on the total weight of the inner polymer layer. Here, the inner polymer layer may comprise 2 or more, preferably 2 or 3, of the aforementioned polymers in a polymer blend, for example at least a proportion of the LDPE and the mPE, or at least a proportion of the LDPE and the HDPE. Further preferably, the inner polymer layer may comprise 2 or more, preferably 3, sublayers superimposing each other, which preferably form the inner polymer layer. These sub-layers are preferably layers obtained by co-extrusion.

In a preferred embodiment, the inner polymer layer comprises, in the direction from the outer side of the planar composite to the inner side of the planar composite, a first sublayer comprising an LDPE in an amount of at least 50% by weight, preferably at least 60% by weight, more preferably at least 70% by weight, even more preferably at least 80% by weight, most preferably at least 90% by weight, each based on the weight of the first sub-layer; and a further sub-layer comprising a blend, wherein the blend comprises an LDPE in a proportion of at least 30% by weight, preferably at least 40% by weight, more preferably at least 50% by weight, more preferably at least 60% by weight, most preferably at least 65% by weight, and an mPE in a proportion of at least 10% by weight, preferably at least 15% by weight, more preferably at least 20% by weight, most preferably at least 25% by weight, in each case based on the weight of the blend. In this case, the further sublayer preferably comprises the blend in a proportion of at least 50% by weight, preferably at least 60% by weight, more preferably at least 70% by weight, even more preferably at least 80% by weight, most preferably at least 90% by weight, in each case based on the weight of the further sublayer. Particularly preferably, the further sub-layer consists of the blend.

In a further preferred embodiment, the inner polymer layer comprises, in the direction from the outer side of the planar composite to the inner side of the planar composite, a first sub-layer comprising an HDPE in an amount of at least 30% by weight, preferably at least 40% by weight, more preferably at least 50% by weight, more preferably at least 60% by weight, most preferably at least 70% by weight, and an LDPE in an amount of at least 10% by weight, preferably at least 15% by weight, more preferably at least 20% by weight, in each case based on the weight of the first sub-layer: a second sub-layer comprising an LDPE in an amount of at least 50% by weight, preferably at least 60% by weight, more preferably at least 70% by weight, still more preferably at least 80% by weight, most preferably at least 90% by weight, in each case based on the weight of the second sub-layer:

and a third sub-layer comprising a blend, wherein the blend comprises an LDPE in an amount of at least 30% by weight, preferably at least 40% by weight, more preferably at least 50% by weight, even more preferably at least 60%, most preferably at least 65% by weight, and an mPE in a proportion of at least 10%, preferably at least 15%, more preferably at least 20%, most preferably at least 25%, by weight, each based on the weight of the blend. Here, the third sub-layer preferably comprises the blend in a proportion of at least 50% by weight, preferably at least 60% by weight, more preferably at least 70% by weight, even more preferably at least 80% by weight, most preferably at least 90% by weight, in each case based on the weight of the third sub-layer. Particularly preferably, the third sub-layer consists of the blend.

### Outer Polymer Layer

The outer polymer layer preferably comprises a polyethylene or a polypropylene or both. Preferred polyethylenes are LDPE and HDPE as well as mixtures thereof. A preferred outer polymer layer comprises at least 50% by weight, preferably at least 60% by weight, more preferably at least 70% by weight, even more preferably at least 80% by weight, most preferably at least 90% by weight, in each case based on the weight of the outer polymer layer, of one or more LDPE.

### Intermediate Polymer Layer

The intermediate polymer layer preferably comprises at least one polyethylene or at least one polypropylene or both. Here, particularly preferred polyethylenes are LDPE. Preferably, the intermediate polymer layer comprises the at least one polyethylene or the at least one polypropylene or both together in a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, in each case based on the total weight of the intermediate polymer layer. Additionally or alternatively, the intermediate polymer layer preferably includes an HDPE, preferably in a proportion of at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, each based on the total weight of the intermediate polymer layer. Here, the intermediate polymer layer preferably comprises the aforementioned polymers in a polymer blend.

### Barrier Layer

The barrier layer can be any material which seems suitable to the skilled person for this purpose, which has a sufficient barrier effect, especially against oxygen. For this purpose, the barrier layer preferably has an oxygen permeation rate of less than 50 cm³/(m²·day·atm), preferably less than 40 cm³/(m²·day·atm), more preferably less than 30 cm³/(m²·day·atm), more preferably less than 20 cm³/(m²·day·atm), more preferably less than 10 cm³/(m²·day·atm), even more preferably less than 3 cm³ (m²·day·atm), most preferably not more than 1 cm³ (m²·day· atm). The barrier layer preferably additionally exhibits a barrier effect against water vapour. Accordingly, the barrier layer is preferably an oxygen barrier layer and further preferably additionally a water vapour barrier layer. In addition, the barrier layer preferably has a barrier effect against visible light, i.e. it is additionally a light barrier layer.

The barrier layer is preferably selected from
a. a plastic layer;
b. a metal layer;
c. an oxide layer: or
d. a combination of at least two from a. to c.

If the barrier layer according to alternative a. is a plastic layer, this preferably comprises at least 70% by weight, particularly preferably at least 80% by weight and most preferably at least 95% by weight of at least one plastic which is known to the person skilled in the art for this purpose, in particular because of aroma or gas barrier properties suitable for packaging containers. Plastics, in particular thermoplastics, which can be considered here are N- or O-bearing plastics both by themselves and in mixtures of two or more. According to the invention, it may prove advantageous if the plastic layer has a melting temperature in a range of more than 155 to 300° C., preferably in a range of 160 to 280° C. and particularly preferably in a range of 170 to 270° C.

Further preferably, the plastic layer has a basis weight in a range from 2 to 120 g/m², preferably in a range from 3 to 60 g/m², particularly preferably in a range from 4 to 40 g/m² and more preferably from 6 to 30 g/m². Further preferably, the plastic layer is obtainable from melts, for example by extrusion, in particular layer extrusion. Furthermore, preferably, the plastic layer can also be introduced into the planar composite by lamination. In this case, it is preferred that a film is incorporated into the planar composite. According to another embodiment, plastic layers can also be selected which are obtainable by deposition from a solution or dispersion of plastics.

Suitable polymers are preferably those having a weight average molecular weight, determined by gel permeation chromatography (GPC) using light scattering, in a range of 3·10³ to 1·10⁷ g/mol, preferably in a range of 5·10³ to 1·10⁶ g/mol and particularly preferably in a range of 6·10³ to 1·10⁵ g/mol. Suitable polymers are in particular polyamide (PA) or polyethylene vinyl alcohol (EVOH) or a mixture thereof. Among the polyamides, all PAs which appear to the person skilled in the art to be suitable for use according to the invention can be considered.

All EVOHs that appear suitable to the person skilled in the art for use according to the invention can be considered as EVOH. Examples of these are commercially available under the trade names EVAL™ of EVAL Europe NV, Belgium in a variety of different versions, for example the grades EVAL™ F104B or EVAL™MLR171B. Preferred EVOH have at least one, two, multiple or all of the following properties:
an ethylene content in a range from 20 to 60 mol-%, preferably from 25 to 45 mol-%;
a density in a range from 1.0 to 1.4 g/cm³, preferably from 1.1 to 1.3 g/cm³;
a melting point in a range of more than 155° C. and up to 235° C., preferably from 165 to 225° C.;
an MFR value (210° C./2.16 kg when T_{S(EVOH)}<210° C.: 230° C./2.16 kg when 210° C.<T_{S(EVOH)}<230° C.) in a range from 1 to 25 g/10 min, preferably from 2 to 20 g/10 min;
an oxygen permeation rate in a range of 0.05 to 3.2 cm³·20 μm/(m²· day· atm), preferably in a range of 0.1 to 1 cm³·20 μm/(m²·day·atm).

Preferably, at least one polymer layer, more preferably the inner polymer layer, or preferably all polymer layers have a melting temperature below the melting temperature of the barrier layer. This is particularly true if the barrier layer is formed of a plastic. In this case, the melting temperature of the at least one polymer layer, in particular the inner polymer layer, and the melting temperature of the barrier layer preferably differ by at least 1 K, particularly preferably by at least 10 K, even more preferably by at least 50 K, and furthermore preferably by at least 100 K. The temperature difference should preferably only be selected so high that it does not result in a melting of the barrier layer, in particular not in a melting of the plastic layer, during folding.

According to alternative b., the barrier layer is a metal layer. In principle, all layers with metals known to the skilled person and capable of creating a high light and oxygen impermeability are suitable as a metal layer. According to a preferred embodiment, the metal layer can be present as a foil or as a deposited layer, e.g. after physical vapour deposition. Preferably, the metal layer is an uninterrupted layer. According to a further preferred embodiment, the metal layer has a thickness in a range from 3 to 20 μm, preferably in a range from 3.5 to 12 μm and particularly preferably in a range from 4 to 10 μm.

Preferred metals are aluminium, iron or copper. A steel layer, e.g., in the form of a foil, may be preferred as the iron layer. Further preferably, the metal layer is a layer with aluminium, preferably an aluminium layer, further preferably an aluminium foil. The aluminium layer can suitably consist of an aluminium alloy, for example AlFeMn, AlFe1.5Mn, AlFeSi or AlFeSiMn. The purity is often 97.5% and higher, preferably 98.5% and higher, based on the entire aluminium layer. In a particular embodiment, the metal layer consists of an aluminium foil. Suitable aluminium foils have a ductility of more than 1%, preferably more than 1.3% and particularly preferably more than 1.5%, and/or a tensile strength of more than 30 N/mm², preferably more than 40 N/mm² and particularly preferably more than 50 N/mm². Suitable aluminium foils show a drop size in the pipette test of more than 3 mm, preferably more than 4 mm and particularly preferably more than 5 mm. Suitable alloys for creating aluminium layers or foils are commercially available under the designations EN AW 1200, EN AW 8079 or EN AW 8111 from Hydro Aluminium Deutschland GmbH or Amcor Flexibles Singen GmbH. In the case of a metal layer as a barrier layer, an adhesion promoter layer can be provided on one or both sides of the metal layer, preferably adjacent to the metal layer on its respective side.

Furthermore, an oxide layer can be selected as the barrier layer according to alternative c. All oxide layers that are familiar to the person skilled in the art and appear suitable for achieving a barrier effect against light, vapour and/or gas can be considered as oxide layers. A preferred oxide layer is a semi-metal oxide layer or a metal oxide layer or both. A preferred semi-metal oxide layer is a layer based on one or more silicon oxide compounds (SiOx layer). Preferred metal oxide layers are layers based on the previously mentioned metals aluminium, iron or copper, as well as such metal oxide layers based on titanium oxide compounds, whereby an aluminium oxide layer (AlOx layer) is particularly preferred. According to a preferred embodiment, the oxide layer may be present as a deposited layer. A deposited oxide layer is exemplarily produced by vapour deposition of the oxide layer on a barrier substrate. A preferred process for this is physical vapour deposition (PVD) or chemical vapour deposition (CVD), preferably plasma-assisted. The oxide layer is preferably an uninterrupted layer.

The barrier substrate can consist of any material which appears to the skilled person to be suitable for use as a barrier substrate according to the invention. In this case, the barrier substrate is preferably suitable for being coated with an oxide layer. Preferably, a layer surface is sufficiently smooth for this purpose. Further preferably, the barrier substrate has a thickness in a range from 2 to 30 μm, preferably from 2 to 28 μm, more preferably from 2 to 26 μm, more preferably from 3 to 24 μm, more preferably from 4 to 22 μm, most preferably from 5 to 20 μm. Furthermore, the barrier substrate preferably exhibits a barrier effect against oxygen or water vapour or both. Preferably, a barrier effect of the barrier substrate against permeation of oxygen is greater than a barrier effect of the oxide layer against permeation of oxygen. Preferably, the barrier substrate has an oxygen permeation rate in a range from 0.1 to 50 cm³/(m²· d· bar), preferably from 0.2 to 40 cm³/(m²· d· bar), more preferably from 0.3 to 30 cm³/(m²· d· bar). A preferred barrier substrate includes, more preferably consists of, cellulose or a polymer or both. A preferred polymer here is an oriented polymer. Preferably, the oriented polymer is mono-axially oriented or bi-axially oriented. A preferred polymer is a thermoplastic polymer. Preferably, the barrier substrate consists of the polymer. Preferably, the barrier substrate comprises a polymer selected from the group consisting of a polycondensate, a polyethylene, a polypropylene, a polyvinyl alcohol, or a combination of at least two of them in a proportion of at least 50% by weight, preferably at least 60% by weight, more preferably at least 70% by weight, more preferably at least 80% by weight, most preferably at least 90% by weight, each based on the weight of the barrier substrate. More preferably, the barrier substrate consists of the aforementioned polymer. A preferred polypropylene is oriented, in particular monoaxially oriented (oPP) or biaxially oriented (BoPP). A preferred polycondensate is a polyester or polyamide (PA) or both. A preferred polyester is one selected from the group consisting of a polyethylene terephthalate (PET), a polylactide (PLA), and a vinyl polymer, or a combination of at least two thereof. A preferred vinyl polymer is a vinyl alcohol copolymer or a polyvinyl alcohol or both. A preferred polyvinyl alcohol is a vinyl alcohol copolymer. A preferred vinyl alcohol copolymer is an ethylene-vinyl alcohol copolymer.

### Carrier Layer

The carrier layer can be any material suitable to the skilled person for this purpose, which has sufficient strength and rigidity to give the container sufficient stability that the container substantially retains its shape when filled. In particular, this is a necessary feature of the carrier layer as the invention relates to the technical field of dimensionally stable containers. Such dimensionally stable containers are fundamentally to be distinguished from bags and pouches, which are usually made of thin films. In addition to a number of plastics, plant-based fibrous materials, in particular cellulose, preferably sized, bleached and/or unbleached cellulose, are preferred, with paper and cardboard being particularly preferred. Accordingly, a preferred carrier layer includes a plurality of fibres. The basis weight of the carrier layer is preferably in a range of 120 to 450 g/m², more preferably in a range of 130 to 400 g/m² and most preferably in a range of 150 to 380 g/m². A preferred cardboard generally has a single or multi-layer structure and may be coated on one or both sides with one or more top layers. Furthermore, a preferred cardboard has a residual moisture content of less than 20% by weight, preferably from 2 to 15% by weight and particularly preferably from 4 to 10% by weight based on the total weight of the cardboard. A particularly preferred cardboard has a multi-layer structure. Furthermore, the cardboard preferably has on the surface facing the environment at least one, but particularly preferably at least two, plies of a cover layer known to the skilled person as a “paper coating”. Furthermore, a preferred cardboard has a Scott-Bond value (according to Tappi 569) in a range from 100 to 360 J/m², preferably from 120 to 350 J/m² and particularly preferably from 135 to 310 J/m². The above ranges make it possible to provide a composite from which a container can be folded with high tightness, easily and to low tolerances.

The carrier layer preferably has a bending stiffness in a first direction in a range from 70 to 700 mN, more preferably from 80 to 650 mN. In the case of a carrier layer comprising a plurality of fibres, the first direction is preferably an orientation direction of the fibres. A carrier layer comprising a plurality of fibres further preferably has a bending stiffness in a further direction perpendicular to the first direction in a range from 10 to 350 mN, more preferably from 20 to 300 mN. A preferred planar composite with the carrier layer has a bending stiffness in the first direction in a range of 100 to 700 mN. Further preferably, the aforementioned planar composite has a bending stiffness in the further direction in a range of 50 to 500 mN.

Preferably, the carrier layer comprises at least 2, more preferably at least 3, particularly preferably exactly 3 or 5, sub-layers, each of a fibre-containing material, wherein the sub-layers are superimposed to one another and joined to one another. The fibre-containing materials of the individual sub-layers may differ at least partially from one another or may all be the same. A further particularly preferred carrier layer comprises, as superimposed and interconnected sub-layers of a sub-layer sequence, preferably in a direction from an outer side of the carrier layer to an inner side of the carrier layer, a first sub-layer comprising a fibrous material, a second sub-layer comprising a fibrous material and a third sub-layer comprising a fibrous material. The fibre-containing materials of the first to third sub-layers may be the same or different from each other. Furthermore, in addition to the aforementioned layer sequence, a preferred carrier layer includes at least one cover layer as a further sub-layer. Preferably, the layer sequence of first to third sub-layers is superimposed on an outer side of the carrier layer with at least one cover layer as a further sub-layer. Alternatively or additionally preferred, the layer sequence of first to third sub-layers is superimposed on an inner side of the carrier layer with at least one cover layer as a further sub-layer. Preferably, an average fibre length of the plurality of fibres of the fibrous material of the first sub-layer is less than an average fibre length of the plurality of fibres of the fibrous material of the third sub-layer, preferably by 0.1 to 3 mm, more preferably by 0.5 to 2.5 mm, most preferably by 1 to 2.0 mm.

### Cover Layer

A preferred cover layer is a “paper coating”. In papermaking, a “paper coating” is a cover layer comprising inorganic solid particles, preferably pigments and additives. The “paper coating” is preferably applied as a liquid phase, preferably as a suspension or dispersion, to a surface of a paper- or cardboard-comprising layer. A preferred dispersion is an aqueous dispersion. A preferred suspension is an aqueous suspension. Another preferred liquid phase includes inorganic solid particles, preferably pigments: a binder; and additives. A preferred pigment is selected from the group consisting of calcium carbonate, kaolin, talc, silicate, a plastic pigment and titanium dioxide. A preferred kaolin is a calcined kaolin. A preferred calcium carbonate is one selected from the group consisting of marble, chalk and a precipitated calcium carbonate (PCC) or a combination of at least two thereof. A preferred silicate is a layered silicate. A preferred plastic pigment is spherical, preferably hollow spherical. A preferred binder is one selected from the group consisting of styrene-butadiene, acrylate, acrylonitrile, a starch and a polyvinyl alcohol or a combination of at least two thereof, acrylate being preferred. A preferred starch is one selected from the group consisting of cationically modified, anionically modified, and fragmented or a combination of at least two thereof. A preferred additive is one selected from the group consisting of a rheology modifier, a shade dye, an optical brightener, a carrier, a flocculant, a deaerator, and a surface energy modifier, or a combination of at least two thereof. A preferred deaerator is a coating colour deaerator, preferably silicone-based or fatty acid-based or both. A preferred surface energy modifier is a surfactant.

### Fibrous Material

Here, the terms “fibrous material” and “fibre-containing material” are synonymous and encompass any material or layer, which comprises a plurality of fibres, such as preferred carrier layers. Thus, the fibrous material includes a plurality of fibres, and preferably at least one further constituent. A preferred further constituent is a sizing agent. A preferred sub-layer of a fibrous material includes a plurality of fibres and at least one sizing agent.

### Fibres

The fibres of a fibre-containing material can be any fibre which appears to the skilled person to be suitable for use in accordance with the invention, in particular any fibre known in the manufacture of paper, cardboard or paperboard. Fibres are linear, longitudinally extended structures having a ratio of length to diameter or thickness of at least 3:1. For some fibres, the aforementioned ratio is not greater than 100:1. For use in this document, long fibres have an average fibre length in a range of 3 to 4 mm and short fibres have an average fibre length in a range of 0.4 to 2 mm.

Preferred fibres are plant fibres. Plant fibre is a collective term for fibres of plant origin, i.e. fibres obtained from plants. Plant fibres occur in plants as conducting bundles in the stem or trunk, the bark (for example as bast) and as seed appendages. A subdivision is made according to DIN 60001-1:2001-05 Textile fibre materials-Part 1: “Natural fibres and abbreviations”, Beuth Verlag, Berlin 2001, p. 2 into seed fibres, bast fibres and hard fibres or according to DIN EN ISO 6938:2015-01 “Textiles-Natural fibres-Generic names and definitions”, Beuth Verlag, Berlin 2015, p. 4. into seed fibres, bast fibres, leaf fibres and fruit fibres, which thus makes a subdivision of the hard fibres. In the context of the invention, preferred plant fibres are predominantly produced from the wood of trees. A preferred wood in this respect is a coniferous wood, i.e., a wood of a coniferous tree, or a deciduous wood, i.e. a wood of a deciduous tree. In the case of coniferous wood, tracheids are preferred. In the case of deciduous wood, libriforms are preferred.

In the context of the invention, preferred fibres comprise cellulose pulp or a wood pulp, or both, and preferably the fibres consist thereof. A preferred wood pulp is one selected from the group consisting of groundwood pulp, pressure groundwood pulp, and a thermo-mechanical pulp (TMP), or a combination of at least two thereof. A preferred thermo-mechanical pulp is a chemithermo-mechanical pulp (CTMP). In this case, the wood pulp is characterised by a greater proportion of lignin compared to the cellulose pulp, which can be detected by means of red colouring with phloroglucin solution. In the context of the invention, preferred fibres are obtained from the wood of a tree selected from the group consisting of spruce, pine, birch, and eucalyptus, or a combination of at least two thereof. The fibres of the plurality of fibres of a preferred fibre-containing material have at least one of the following properties:
A) an average fibre length in a range from 0.2 to 6 mm, preferably from 0.2 to 4.5 mm, more preferably from 0.5 to 4.0 mm, more preferably from 1.0 to 4.0, even more preferably from 2.0 to 4.0, most preferably from 3.0 to 4.0 mm,
B) a coarseness in a range from 50 to 400 μg/m, preferably from 100 to 300 μg/m, more preferably from 120 to 300 μg/m, even more preferably from 120 to 250 μg/m, most preferably from 130 to 200 μg/m,
C) an average wall thickness in a range from 2 to 10 μm, preferably from 3 to 9 μm, more preferably from 4 to 9 μm, more preferably from 5 to 8 μm, even more preferably from 6 to 8 μm, most preferably from 6 to 7 μm,
D) a mean outer diameter in a range from 10 to 50 μm, more preferably from 10 to 45 μm, more preferably from 20 to 45 μm, more preferably from 25 to 45 μm, more preferably from 30 to 45 μm, still more preferably from 30 to 40 μm, most preferably from 32 to 40 μm.

Here, the above property under point A) is particularly preferred.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. Another preferred polyolefin is an mPolyolefin (polyolefin produced by means of a metallocene catalyst). Suitable polyethylenes have a melt flow rate (MFI−melt flow index=MFR-melt flow rate) in a range from 1 to 25 g/10 min, preferably in a range from 2 to 20 g/10 min and particularly preferably in a range from 2.5 to 15 g/10 min, and/or a density in a range of 0.910 g/cm³ to 0.935 g/cm³, preferably in a range of 0.912 g/cm³ to 0.932 g/cm³, and more preferably in a range of 0.915 g/cm³ to 0.930 g/cm³.

mPolymer

An mPolymer is a polymer produced by means of a metallocene catalyst. A metallocene is an organometallic compound in which a central metal atom is located between two organic ligands, such as cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two thereof. A preferred mPolyolefin is characterised by at least a first melting temperature and a second melting temperature. Preferably, the mPolyolefin is characterised by a third melting temperature in addition to the first and second melting temperatures. A preferred first melting temperature is in a range from 84 to 108° C., preferably from 89 to 103° C., more preferably from 94 to 98° C. A preferred second melting temperature is in a range from 100 to 124° C., preferably from 105 to 119° C., more preferably from 110 to 114° C.

### Adhesion/Adhesion Promoter Layer

An adhesion promoter layer is a layer of the planar composite that includes at least one adhesion promoter in a sufficient amount such that the adhesion promoter layer improves adhesion between layers adjacent to the adhesion promoter layer. For this purpose, the adhesion promoter layer preferably comprises an adhesion promoter polymer. Accordingly, the adhesion promoter layers are preferably polymeric layers. An adhesion promoter layer may be located between layers of the planar composite which are not directly adjacent to each other, preferably between the barrier layer and the inner polymer layer. Suitable adhesion promoters in an adhesion promoter layer are all plastics which, by functionalisation by means of suitable functional groups, are suitable for producing a firm bond by forming ionic bonds or covalent bonds to a surface of a respective adjacent layer. Preferably, these are functionalised polyolefins, in particular acrylic acid copolymers obtained by co-polymerisation of ethylene with acrylic acids such as acrylic acid, methacrylic acid, crotonic acid, acrylates, acrylate derivatives or double bond-bearing carboxylic acid anhydrides, for example maleic anhydride, or at least two thereof. Among these, polyethylene-maleic anhydride graft polymers (EMAH), ethylene-acrylic acid copolymers (EAA) or ethylene-methacrylic acid copolymers (EMAA) are preferred, which are marketed for example under the trade names Bynel® and Nucrel 0609HSAR by DuPont or Escor 6000 ExCo3 by ExxonMobile Chemicals.

Ethylene-alkyl acrylate copolymers are also preferred as adhesion promoters. The alkyl group preferably selected is a methyl, ethyl, propyl, i-propyl, butyl-, i-butyl or a pentyl group. Further preferably, the adhesion promoter layer may comprise blends of two or more different ethylene alkyl acrylate copolymers. Equally preferably, the ethylene alkyl acrylate copolymer may have two or more different alkyl groups in the acrylate function, e.g., an ethylene alkyl acrylate copolymer in which both methyl acrylate units and ethyl acrylate units are present in the same copolymer.

According to the invention, it is preferred that the adhesion between the carrier layer, a polymer layer or the barrier layer to the respective next layer is at least 0.5 N/15 mm, preferably at least 0.7 N/15 mm and particularly preferably at least 0.8 N/15 mm. In one embodiment according to the invention, it is preferred that the adhesion between a polymer layer and a carrier layer is at least 0.3 N/15 mm, preferably at least 0.5 N/15 mm and particularly preferably at least 0.7 N/15 mm. Furthermore, it is preferred that the adhesion between the barrier layer and a polymer layer is at least 0.8 N/15 mm, preferably at least 1.0 N/15 mm and particularly preferably at least 1.4 N/15 mm. In the case that the barrier layer indirectly follows a polymer layer via an adhesion promoter layer, it is preferred that the adhesion between the barrier layer and the adhesion promoter layer is at least 1.8 N/15 mm, preferably at least 2.2 N/15 mm and particularly preferably at least 2.8 N/15 mm. In an embodiment, the adhesion between the individual layers is so strong that the adhesion test results in a tearing of the carrier layer, in particular, in the case of cardboard as the carrier layer in a so-called cardboard fibre tear.

### Container Precursor

A container precursor is a preliminary stage of the container that is created during the production of a, preferably closed, container. In this case, the container precursor contains the planar composite, preferably as a blank. The planar composite can be unfolded or folded. Preferably, the container precursor consists of the blank. A preferred container precursor is cut to size and designed to produce a single, preferably closed, container. A preferred container precursor which is cut to size and designed to produce a single container is also referred to as a sleeve. Here the sleeve includes the planar composite folded, preferably along at least 2 longitudinal folds, more preferably along 4 longitudinal folds. These longitudinal folds are preferably, but not necessarily, arranged and configured to form longitudinal edges of a closed container formed at least in part from the container precursor. Further, the sleeve includes a longitudinal seam along which a first longitudinal margin of the blank is joined to a further longitudinal margin. Here, the sleeve is open in a top region and a bottom region. A preferred container precursor is formed in one piece.

### Container

The closed container according to the invention is preferably a foodstuff container. Alternatively or additionally preferred, the closed container according to the invention is a dimensionally stable container. Alternatively or additionally preferred, the closed container according to the invention is a liquid-tight container. The container wall of the closed container according to the invention is thus preferably dimensionally stable, i.e., substantially retains its shape during filling of the container and handling for transport as well as for storage. Preferably, the closed container according to the invention includes a standing base and a head portion opposite the standing base in the longitudinal direction of the closed container. Preferably, a central portion of the closed container is arranged between the standing base and the head portion. Preferably, the central portion is at least partially, preferably completely, substantially prism-shaped, preferably cuboid-shaped. Preferably, the head portion is at least partially substantially in the shape of a regular truncated pyramid. Preferably, the standing base is adjacent to the central portion. Alternatively or additionally preferred, the central portion is adjacent to the head portion. Preferably, the container interior of a closed container according to the invention contains a foodstuff. Preferably, the container wall is liquid-tight.

The container wall can consist of different materials. It is conceivable that other elements are used in addition to the planar composite, for example one or more non-planar components. a Preferred non-planar component is a moulded component made of plastic. Such moulded component can be used in particular in the head portion or the standing base, especially preferably in the head portion. In any case, however, it is preferred that at least 50%, preferably at least 60%, more preferably at least 70%, particularly preferably at least 80%, and furthermore preferably at least 90%, of the surface of the container wall facing away from the container interior (outer surface) consists of the planar composite.

In a preferred embodiment of the invention, a first part of the container wall is formed from the planar composite or a blank thereof: wherein a further part of the container wall is formed from a non-planar component: wherein the first part and the further part together form the container wall such that the closed container is closed. The first part of the container wall is preferably cup-shaped. Preferably, the non-planar component bounds the container interior in the longitudinal direction of the closed container. Preferably, the non-planar component forms an upper side of the closed container for this purpose. Preferably, the planar composite or the blank bounds the container interior laterally, or in a direction opposite to the longitudinal direction of the closed container, or both.

In a preferred embodiment of the invention, the closed container includes a blank of the planar composite and a non-planar component: wherein a bending stiffness of the planar composite is greater for bending in a first composite direction than for bending in a further composite direction perpendicular to the first composite direction: wherein the blank:
includes a first transverse margin and a further transverse margin opposite the first transverse margin in a longitudinal direction of the closed container, and
forms a first part of a container wall surrounding a container interior of the closed container:
   wherein a non-planar component forms a further part of the container wall; wherein the further transverse margin is joined to the non-planar component: wherein an edge of the further transverse margin extends along at least 50%, preferably at least 60%, more preferably at least 70%, more preferably at least 80%, more preferably at least 90%, still more preferably at least 95%, most preferably 100%, of its length at an angle in an angular range of +30°, preferably +25°, more preferably +20°, more preferably +15°, more preferably +10°, more preferably +5°, still more preferably +3°, most preferably 0°, about the first composite direction. Preferably the further transverse margin, preferably the edge of the further transverse margin, surrounds the non-planar component, preferably along an entire circumference of the non-planar component. Preferably, the closed container includes a standing base including the first transverse margin and, in the longitudinal direction of the closed container opposite the standing base, a head portion including the further transverse margin. Preferably, the standing base is formed entirely from the blank.

In a preferred embodiment of the invention, the head portion of the closed container includes at least 3, preferably from 3 to 12, more preferably from 3 to 10, more preferably from 3 to 8, more preferably from 3 to 6, still more preferably 3 or 4, most preferably 4, preferably planar, head side surfaces formed from the blank, which are inclined to each other in the longitudinal direction of the closed container, such that each of the head side surfaces is at an angle in a range from 55 to 70°, preferably from 55 to 69°, more preferably from 55 to 68°, more preferably from 55 to 67°, more preferably from 55 to 66°, more preferably from 55 to 65°, more preferably from 55 to 64°, more preferably from 56 to 63°, more preferably from 57 to 62°, more preferably from 58 to 61°, still more preferably from 58.5 to 60.0°, to the longitudinal direction. Alternatively preferred, the preceding angle is in a range from 56 to 70°, more preferably from 57 to 70°, more preferably from 58 to 70°, more preferably from 59 to 70°, more preferably from 60 to 70°, more preferably from 61 to 70°, more preferably from 62 to 69°, more preferably from 63 to 68°, more preferably from 64 to 67°, still more preferably from 65.0 to 66.0°.

In a preferred embodiment of the invention, the container has 4 longitudinal edges, each longitudinal edge, each longitudinal edge of the closed container extending along the length of the closed container from the standing base to the head portion, wherein the closed container has a square cross-section along its length between the standing base and the head portion at least in sections, preferably continuously, wherein the shortest of the 4 longitudinal edges has a length 1, wherein a ratio of the length 1 to an edge length a of the square cross-section lies in a range from 1.3 to 2.95, preferably from 1.35 to 2.95, more preferably from 1.38 to 2.8, most preferably from 1.39 to 2.8. The length 1 is the height of the closed container excluding its head portion. Preferably, the 4 longitudinal edges are of equal length. In principle, however, it is also possible that, for example, 2 longitudinal edges are shorter than the other two longitudinal edges. In this case, the length 1 designates the shorter longitudinal edges.

Element Other than the Planar Composite or the Blank/Non-Planar Component

In principle, any element which appears suitable to the person skilled in the art in the context of the invention can be used as an element other than the planar composite or the blank. A preferred element other than the planar composite or the blank is a non-planar component. The non-planar component is three-dimensional, i.e., not planar or sheet-like. A preferred non-planar component is a moulded component. A preferred moulded component is an injection moulded component. Alternatively or additionally preferred, the element other than the planar composite or the blank is made of plastic. An alternatively or additionally preferred element other than the planar composite or the blank is formed in one piece. Preferably, the element other than the planar composite or the blank forms a top surface of the head portion of the closed container. A preferred top surface is the top surface of a regular truncated pyramid. Preferably, the element other than the planar composite or the blank forms a further part of the container wall of the closed container, while the planar composite or blank forms a first part of the container wall of the closed container.

Preferably, the element other than the planar composite or the blank includes a base member and a spout arranged on the base member. A spout is a component, the shape of which is intended to facilitate the targeted pouring of liquid. A preferred spout takes the form of a tube. Preferably, the tube includes a screw thread on its outer side. Preferably, the spout has a pouring aperture which is closed by a closure element. A preferred closure element is planar. A preferred planar closure element is a laminate or a foil. A preferred foil is a plastic foil. Here the base member preferably includes a base plate, and at least 3, preferably 3 to 12, more preferably 3 to 10, more preferably 3 to 8, more preferably 3 to 6, still more preferably 3 or 4, most preferably exactly 4, side walls: the spout being arranged on a first side of the base plate: the side walls being arranged on a further side of the base plate opposite the first side. Preferably, the further side of the base plate in the closed container faces the container interior and the first side of the base plate in the closed container faces away from the container interior. The base plate preferably has a base surface in the form of a polygon. A preferred polygon here is a regular polygon. Alternatively or additionally preferred, the polygon has 3 to 12, more preferably 3 to 10, more preferably 3 to 8, more preferably 3 to 6, still more preferably 3 or 4, most preferably exactly 4, corners. A preferred polygon with 4 corners is a rectangle. A preferred rectangle is a square. Preferably, the base member has as many side walls as the polygon has corners. Preferably, each 2 of the side walls which follow one another in the circumferential direction of the element other than the planar composite or the blank adjoin one another, forming a side edge of the base member. Preferably, the base member and the spout are in one piece with one another. Preferably, the element other than the planar composite or the blank is formed in one piece.

Preferably, the planar composite or blank and the element other than the planar composite or the blank are glued or sealed together or both. Preferably, the further transverse margin of the blank is glued or sealed or both to the element other than the planar composite or the blank. Preferably the planar composite or the blank is joined to one of the side walls, preferably each of the side walls, of the element other than the planar composite or the blank, preferably directly. A preferred element other than the planar composite or the blank, preferably the spout, includes a screw thread. A pouring aperture of the spout is preferably closed. Preferably, an opening aid is arranged in the spout. In this case, the closed container preferably also includes the opening aid.

A preferred opening aid is a cutting aid or a tearing aid or both. Alternatively or additionally preferred, the opening aid is annular. A preferred annular cutting aid is a cutting ring. A preferred annular tear aid is a tear ring. A cap, preferably a screw cap, is preferably arranged on the element other than the planar composite or the blank in such a way that the pouring aperture of the spout is covered by the cap. Preferably, the cap is screwed onto the spout. In this case, the closed container preferably also includes the cap.

### Joining

Any joining method which appears to the skilled person to be suitable for use according to the invention and by which a sufficiently strong connection can be obtained may be considered in the context of the invention. A preferred joining method is a material-to-material joining method. A material-to-material joint is understood herein to be a joint between joining partners which is produced by attractive forces between materials or within a material. A distinction must be made between this and, in particular, form-fitting and friction-fitting joints that are created by geometric shapes or frictional forces. A preferred material-to-material joining method may be one selected from the group consisting of a sealing, a welding, a gluing, and a pressing, or a combination of at least two of them. In the cases of sealing and welding, the joint is created by means of a liquid and its solidification. In the case of gluing, chemical bonds are formed between the surfaces of the two objects to be joined, which create the joint. It is often advantageous in the case of sealing, welding or gluing to press the surfaces to be joined together. A preferred pressing of two layers is a pressing of a respective first surface of a first of the two layers onto a second surface of the second of the two layers facing the first surface over at least 20%, preferably at least 30%, more preferably at least 40%, more preferably at least 50%, more preferably at least 60%, more preferably at least 70%, still more preferably at least 80%, still more preferably at least 90%, most preferably at least 95%, of the first surface. A particularly preferred joining is a sealing or welding. A preferred sealing or welding includes as steps a contacting, a heating and a pressing, wherein the steps are preferably performed in this sequence. Another sequence is also conceivable, in particular the sequence of heating, contacting and pressing.

A preferred heating is a heating of a polymer layer, preferably a thermoplastic layer, more preferably a polyethylene layer or a polypropylene layer or both. Another preferred heating is a heating of a polyethylene layer to a temperature in a range from 80 to 140° C., more preferably from 90 to 130° C., most preferably from 100 to 120° C. Another preferred heating is a heating of a polypropylene layer to a temperature in a range from 120 to 200° C., more preferably from 130 to 180° C., most preferably from 140 to 170° C. Another preferred heating is to a sealing temperature of the polymer layer. A further preferred heating is a heating of an element other than the planar composite or blank, preferably of a non-planar component, more preferably of at least one side wall of a base member, preferably to a temperature above a melting temperature of the first polymer composition. Preferred heating may be by friction, by radiation, by hot gas, by hit solid contact, by mechanical vibration, preferably by ultrasound, by convection, or by a combination of at least two of these.

### Extruding/Extruder

In the context of the invention, every extruder known to the skilled person and which appears to him to be suitable for purposes of the invention comes into consideration. An extruder is a device for shaping a mass, preferably a polymer mass, by pressing through a shaping orifice. A preferred extruder is a screw extruder. A melt extrusion coating is an application of a mass by pressing a melt, forming the mass, through the shaping orifice of an extruder onto a substrate so that a planar layer of the mass superimposing the substrate is obtained. In the case of a polymer composition as a mass, the mass is preferably melted for extrusion coating. During extrusion, the polymers are typically heated to temperatures of 210 to 350° C., measured at the molten polymer film below the exit at the extruder die. Extrusion can be carried out by means of commercially available extrusion tools known to the person skilled in the art, such as extruders, extruder screws, feedblocks, etc. At the end of the extruder there is preferably an orifice through which the polymer melt is pressed. The orifice can have any shape that allows the polymer melt to be extruded. For example, the orifice may be angular, oval or round. Preferably, the orifice has the shape of a slot of a funnel. After the melt layer has been applied to the substrate by means of the method described above, the melt layer is allowed to cool for the purpose of heat-setting. this cooling preferably being effected by quenching via contact with a surface maintained at a temperature in a range from 5 to 50° C., more preferably in a range from 10 to 30° C. Subsequently, at least the flanks are separated from the surface. The separation can be carried out in any way that is familiar to the skilled person and appears suitable in order to separate the flanks quickly, as accurately as possible and cleanly. Preferably, the separation is carried out by means of a knife, laser beam or water jet, or a combination of two or more of these, whereby the use of knives, in particular a pot knife, is particularly preferred.

### Laminating

According to the invention, the superimposing the carrier layer with the barrier layer can be carried out by laminating. In this case, the prefabricated carrier and barrier layers are joined with the aid of a suitable laminating agent. A preferred laminating agent comprises, preferably consists of, an intermediate polymer composition, from which an intermediate polymer layer is preferably obtained.

### Foodstuff

All food products known to the skilled person for human consumption and also animal feed may be considered as foodstuffs. Preferred foodstuff is liquid above 5° C., for example dairy products, soups, sauces and, preferably non-carbonated, beverages.

### Edges

Edges are defined herein as both the linear regions of the container wall of the container according to the invention, which are formed by a folding of the planar composite or blank and at which in each case two, preferably flat, regions of the planar composite or blank adjoin each other, and edges which delimit the dimensions of a blank. The first-mentioned edges are folding edges. These include the side edges of the head portion of the container according to the invention and its longitudinal edges. The second-mentioned edges are cut edges. These include in particular the edge of the further transverse margin. The term “cut edge” herein does not necessarily mean that the blank has been separated from the planar composite by cutting. Rather, the blank can also be punched out of the laminate, for example.

### Directions

The longitudinal direction of the closed container runs from the standing base to the head portion. Here, the longitudinal direction runs along a straight line. Preferably, the longitudinal direction of the closed container runs along a height of the closed container. The circumferential direction of the closed container is perpendicular to the longitudinal direction. Since the circumferential direction runs along the circumference of the closed container, it does not follow a straight line. The planar composite and the blank have directions corresponding to the longitudinal direction and the circumferential direction of the closed container. On the planar composite and on the blank, the longitudinal direction and the circumferential direction are still perpendicular to each other, but here both directions run along straight lines that lie in the plane of planar extension of the planar composite or the blank. On the planar composite and on the blank, the longitudinal direction preferably runs along longitudinal grooves, i.e., along grooves of the at least first plurality of grooves along which longitudinal edges of the closed container run.

The first composite direction and the further composite direction are perpendicular to each other. Both composite directions lie in the plane of planar extension of the planar composite or blank. The plane of planar extension of the planar composite or blank is not necessarily plane in Cartesian coordinates. In particular, if the planar composite or blank is bent or folded, the plane follows this bend or fold. This is particularly the case for the planar composite or blank as part of the closed container according to the invention.

The plane of planar extension of the planar composite or blank is not necessarily planar in Cartesian coordinates. In particular, if the planar composite or blank is bent or folded, the plane follows this bend or fold. This is particularly the case when the planar composite or blank is part of the closed container.

The longitudinal direction of the element other than the planar composite or blank runs along a straight line from the base element to the spout. Preferably, the longitudinal direction of the element other than the planar composite or blank runs along a height of the element other than the planar composite or blank. Additionally or alternatively preferred, the longitudinal direction of the element other than the planar composite or blank runs along a longitudinal axis of the spout. Additionally or alternatively preferred, the longitudinal direction of the element other than the planar composite or blank is perpendicular to the base plate. The circumferential direction of the element other than the planar composite or blank is perpendicular to its longitudinal direction. Since the circumferential direction runs along the circumference of the element other than the planar composite or blank, it does not follow a straight line. Preferably, in the closed container according to the invention, the longitudinal directions of the closed container and of the element other than the planar composite or blank are identical. Additionally or alternatively preferred, in the closed container according to the invention, the circumferential directions of the closed container and of the element other than the planar composite or blank are identical.

### Process Steps

The process steps of the processes according to the invention are carried out in the order of their symbols. In principle, process steps with immediately successive symbols can be carried out one after the other, at the same time or overlapping in time.

### Colourant

Both solid and liquid colourants known to the person skilled in the art and suitable for the present invention may be considered. According to DIN 55943:2001-10, colourant is the collective term for all colouring substances, in particular for dyes and pigments. A preferred colourant is a pigment. A preferred pigment is an organic pigment. Pigments of note in the context of the invention are, in particular, those described in DIN 55943:2001-10 and those described in “Industrial Organic Pigments. Third Edition”. (Willy Herbst, Klaus Hunger Copyright© 2004 WILEY-VCH Verlag Gmbh & Co. KGaA, Weinheim ISBN: 3-527-30576-9). A pigment is a colourant that is preferably insoluble in the application medium. A dye is a colourant that is preferably soluble in the application medium.

### Measurement Methods

The following measurement methods were used within the scope of the invention. Unless otherwise stated, the measurements were carried out at an ambient temperature of 23° C., an ambient air pressure of 100 kPa (0.986 atm) and a relative humidity of 50%.

### Separating Individual Layers

If individual layers of a laminate-such as the barrier layer—are to be examined, the layer to be examined is first separated from the laminate as described below. Three sample pieces of the laminate are cut to size. For this purpose, unfolded and ungrooved areas of the laminate are used, unless otherwise specified. Unless otherwise specified, the sample pieces shall be 4 cm×4 cm. If other dimensions of the layer to be examined are necessary for the examination to be carried out, sufficiently large sample pieces are cut from the laminate. The sample pieces are placed in an acetic acid bath heated to 60° C. (30% acetic acid solution: 30% by weight CHCOOH₃, remainder to 100% by weight H₂O) for 30 minutes. This detaches the layers from each other. Here, if necessary, the layers can also be carefully peeled off from each other manually. If the desired layer cannot be detached sufficiently well, alternatively new sample pieces are used and these are treated in an ethanol bath (99% ethanol) as described above. If there are remnants of the carrier layer (especially in the case of a cardboard layer as carrier layer) on the layer to be examined (for example the outer polymer layer or the intermediate polymer layer), these are carefully removed with a brush. From each of the three films prepared in this way, a sample of sufficient size for the test to be carried out is cut out (unless otherwise specified, with an area of 4 cm²). These samples are then stored at 23° C. for 4 hours and thus dried. The three samples can then be examined. Unless otherwise stated, the test result is the arithmetic mean of the results for the three samples.

### MFR Value

The MFR value is measured according to ISO 1133-1:2012, method A (mass determination method), unless otherwise stated at 190° C. and 2.16 kg).

### Density

The density is measured according to the ISO 1183-1:2013 standard.

### Scott Bond Value

The Scott Bond value is determined in accordance with Tappi 569.

### Melting Temperature

The melting temperature is determined using the DSC method ISO 11357-1, −3. The device is calibrated according to the manufacturer's instructions using the following measurements:
Temperature Indium-Onset Temperature,
Heat of fusion Indium,
Temperature Zinc-Onset Temperature.

The recorded measurement curve can show multiple local maxima (melting peaks), i.e., multiple melting temperatures. If a melting temperature above a certain value is required herein, this condition is fulfilled if one of the measured melting temperatures is above this value. Where reference is made herein to a melting temperature of a polymer layer, a polymer composition or a polymer, the highest melting temperature is always meant in the case of multiple measured melting temperatures (melting peaks), unless otherwise stated.

### Viscosity Number of PA

The viscosity number of PA is measured in 95% sulphuric acid according to the standard DIN EN ISO 307 (2013).

### Molecular Weight Distribution

The molecular weight distribution is measured by gel permeation chromatography using light scattering: ISO 16014-3/-5 (2009-09).

### Residual Moisture Content of Cardboard

The residual moisture content of the cardboard is measured according to the ISO 287:2009 standard.

### Oxygen Permeation Rate

The oxygen permeation rate is determined according to ASTM D3985-05 (2010). The layer thickness of the test specimen is 90 μm±2 μm. The area of the test specimen is 50 cm². The measurements are carried out at an ambient temperature of 23° C., an ambient air pressure of 100 kPa (0.986 atm) and a relative humidity of 50%. The tester is an Ox-Tran 2/22 from Mocon, Neuwied, Germany.

### Detection of Colourants

Detection of organic colourants can be carried out according to the methods described in “Industrial Organic Pigments. Third Edition”. (Willy Herbst, Klaus Hunger Copyright© 2004 WILEY-VCH Verlag GmbH & Co. KGaA, Weinheim ISBN: 3-527-30576-9).

### Adhesion

To determine the adhesion of two adjacent layers, they are fixed on a 90° peel test device, for example from the company Instron “German rotating wheel fixture”, on a rotating roller that rotates at 40 mm/min during the measurement. The samples were previously cut into 15 mm wide strips. On one side of the sample, the layers are detached from each other and the detached end is clamped in a pulling device that points vertically upwards. A measuring device is attached to the pulling device to determine the pulling force. When the roller is rotated, the force required to separate the layers from each other is measured. This force corresponds to the adhesion of the layers to each other and is given in N/15 mm. The separation of the individual layers can be done mechanically, for example, or by a specific pre-treatment, for example by soaking the sample for 3 min in 60° C. warm, 30% acetic acid.

### Bending Stiffness

The following devices are used to determine the bending stiffness of a sheet-like material, in particular a planar composite or cardboard:
bending stiffness tester L&W Bending Tester Code 160, type 977682 from Lorentzen & Wettre, Sweden,
punching machine for bending stiffness samples.

The material to be tested is climatised for 24 h in a standard climate (23° C., 50% relative humidity). The measurement is also carried out in a standard climate. Specimens with a width of 38.1 mm and a length of 69.85 mm are punched out of the material to be tested. In the case of roll material, the specimens are taken at 5 positions distributed over the width of the web. In any case, for each bending direction of the material to be tested, 2 specimens with their length in the corresponding bending direction of the material are punched out of the material at each specimen-taking position. Specimens may only be taken from areas of the material to be tested which neither have grooves nor folds.

Per bending direction to be considered, the bending stiffness (in mN) of the outer side and the opposite inner side is determined. For this purpose, the specimen is placed in the bending stiffness tester with the side to be measured facing forwards and the measurement is started by pressing the green button. For each combination of bending direction and material side (outer side or inner side), the same number of specimens is measured. A 2-point bending test is carried out by the bending stiffness measuring device. In this test, the specimen clamped at one end is deflected at its other end by a measuring edge through a bending angle of 15°. Here, a direction in which the material has the bending stiffness, i.e., the bending direction, is the direction of a straight line connecting the two points at which bending forces are exerted to the specimen in the 2-point bending test. In the case of the bending stiffness tester, this direction is the direction of the shortest straight line from the clamp to the measuring edge. In this direction, the specimen forms a curve during bending. Perpendicular to this direction, a straight fold line would form if the specimen were bent far enough for this. The free clamping length of the specimen is 50 mm. Each specimen may only be used for one measurement. Measurements of the outer side and the inner side on the same specimen are not permitted. The individual measured values are read from the display.

If multiple specimens were measured for each of the combinations of bending direction and material side, the arithmetic mean over the specimens is calculated for each of the combinations individually. The arithmetic mean values are then used as values for each of the combinations of bending direction and material side. The bending stiffness in a specific bending direction is the geometric mean over the values for the combinations of this bending direction/outer side and this bending direction/inner side.

### Liquid Tightness

Crystal oil 60 from Shell Chemicals with methylene blue is used as the test agent for testing the liquid tightness of a container. In order to determine if a certain container type is liquid-tight, 250 identical containers of this container type are tested. Each of the 250 containers is cut open along its circumference so as to obtain a first open cup-like container part containing the sealed container bottom and a second open cup-like container part containing the sealed container top. The first container part with the container bottom and the second container part with the container top are each first emptied and then filled with an amount of the test agent sufficient to completely cover the bottom of the respective cup-like container part. Then the container parts are stored for 24 hours. After the storage time, each container part is examined on its outer side with the naked eye to see whether the test agent has produced a blue discolouration there in the event of a leak. If in this test not more than 1 of the 500 container parts of the 250 identical containers shows such a discolouration, these containers are considered to be liquid-tight.

If different container types are to be compared in terms of the liquid tightness of their head portions, for each of these container types 1,000 identical containers are tested. Here, the second open cup-like container parts with the container tops are prepared and filled with an amount of the test agent as described above. Then the second container parts are stored for 24 hours. After the storage time, each second container part is examined on its outer side with the naked eye to see whether the test agent has produced a blue discolouration there in the event of a leak. For each of the container types to be compared, out of the 1,000 second container parts, the number of second container parts which show blue discolourations is counted. The fewer second container parts show blue discolourations, the better the respective container type performs in terms of liquid tightness.

### Angle (α) Between Grooves for Steep Edges

In order to determine the angle, at which the grooves of a pair of steep edges run in relation to each other in a plane of planar extension of the planar composite, the planar composite is fixed flat on a white sheet of paper. For this purpose, the composite can be stapled to the sheet of paper. Then the two grooves for the pair of steep edges are extended in a straight line on the sheet of paper with a pencil so that the extensions intersect. Now measure the angle between one groove and its extension, on the one hand, and the other groove and its extension, on the other hand, with a geometry set square.

If the preceding angle on a container precursor is to be determined, first the sealing seams of the container precursor, in particular its longitudinal seam, are carefully and slowly loosened manually and the planar composite unfolded so that it is flat. Then proceed as described above.

### Angle (α) Between Steep Edges

In order to determine the angle at which the steep edges of a pair of steep edges of a head side surface run to each other on a closed container, the closed container is prepared as follows.

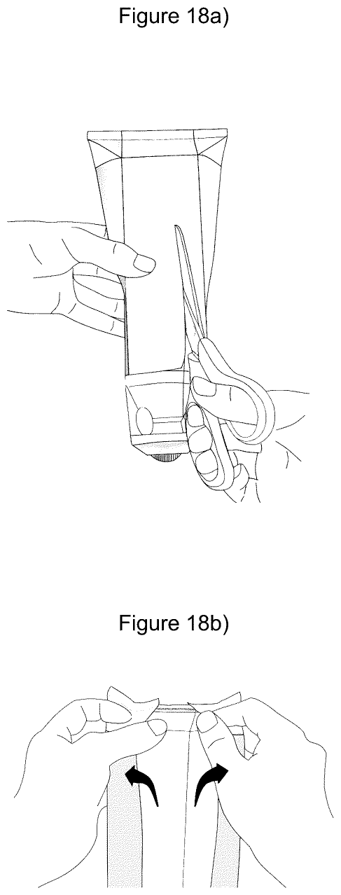

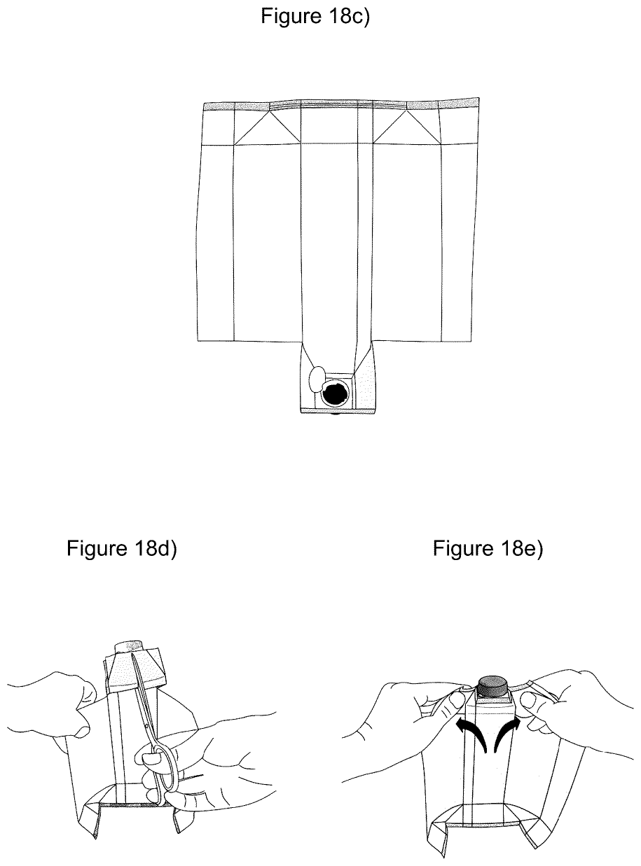

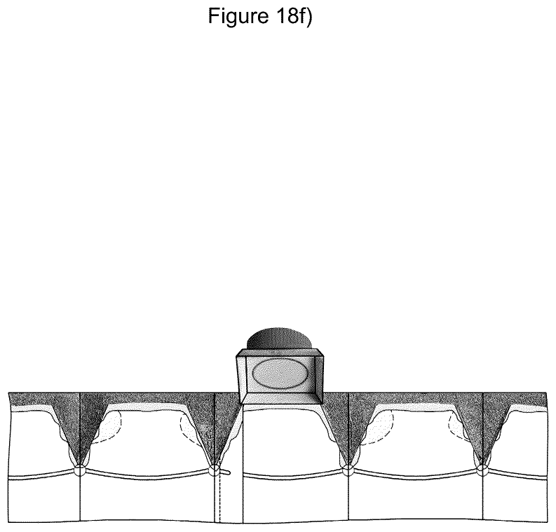

The container is opened below its (possibly truncated pyramid-shaped) head portion with a knife by a lateral cut through 3 of the 4 sides of the container and then emptied. Furthermore, the bottom of the container is unfolded. For this purpose, the sealing of the ears on the bottom is first loosened manually. The seam that closes the bottom of the container is not yet released. Next, the container is cut open along its length with scissors. The cut is made on the side of the container opposite its longitudinal seam. The cut begins at the cut edge below the head portion which has been obtained described above. The cut is made in the direction of the bottom of the container. This is illustrated in FIG. 18a). Then the seam closing the bottom is slowly loosened manually from the inside to the outside. This is illustrated in FIG. 18b). The sample thus obtained is illustrated in FIG. 18c). Further, as shown in FIG. 18d), the head portion on the side opposite the longitudinal seam is cut with the scissors in the longitudinal direction up to the element other than the planar composite or blank. Then the seam joining the composite to the element is slowly released manually starting from the cut. This is illustrated in FIG. 18e). The part of the composite below the head potion is now cut off. The remaining sample is shown schematically in FIG. 18f).

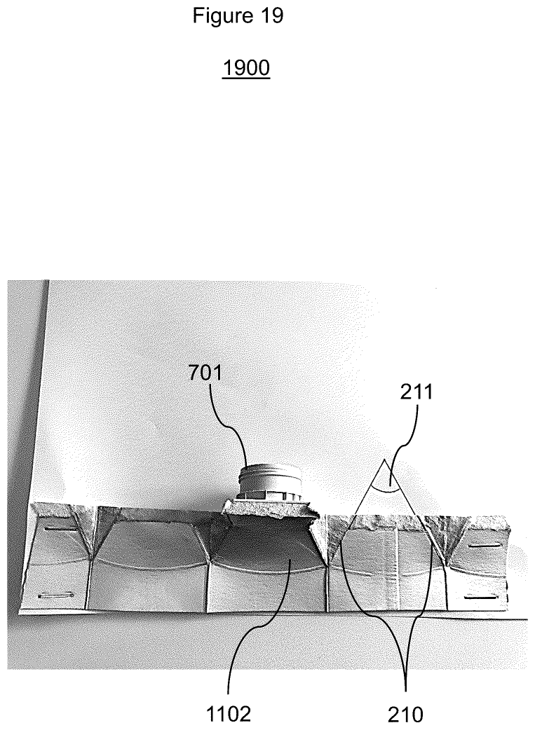

The sample prepared as described above is now fixed flat on a white sheet of paper. For this purpose, the composite can be stapled to the sheet of paper. Then the two grooves for the pair of steep edges are extended in a straight line on the sheet of paper with a pencil so that the extensions intersect. Now the angle at which one groove and its extension, one the one hand, runs to the other groove and its extension, on the other hand, is measured with a geometry set square. FIG. 19 shows the measuring arrangement.

### Compression Stability

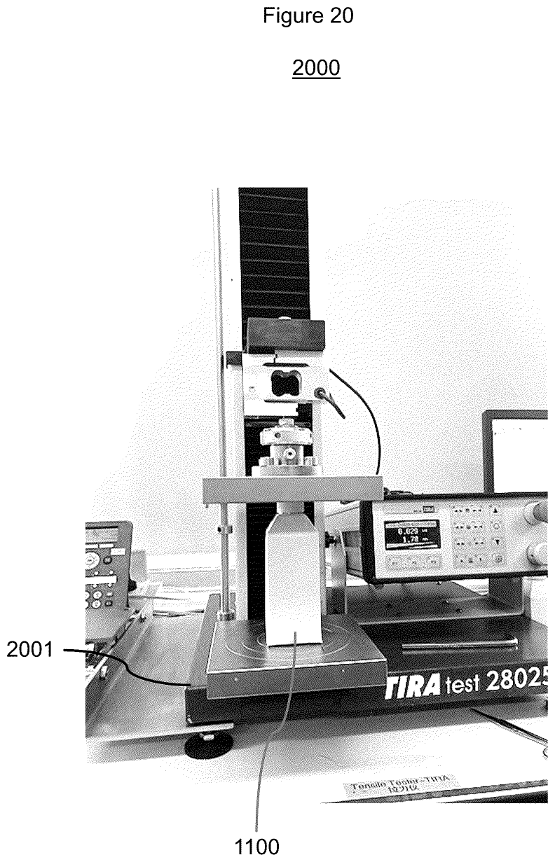

For this test, 5 containers are manufactured and filled with water before closing. The test serves to determine the stability of the container against compression along its longitudinal axis and can be used to evaluate the load capacity of filled containers in the static case of storage and in the dynamic case of transport. The test is carried out on the individual containers in accordance with DIN EN ISO12048. The previous storage of the containers is carried out according to DIN EN ISO 2233:2000. A TIRA test 28025 with force transducer 1000 N (Tira GmbH: Eisfelder Strasse 23/25:96528 Schalkau, Germany) is used as measuring instrument. The mean value of the maximum breaking load (load value) is determined. This describes the value that leads to the failure of the container. The test setup is shown in FIG. 20.

### Grip Stiffness

In this test, 2 non-elastic plastic balls grip the closed container at opposite pressure points and exert a specified force on the container in the lateral direction. It is determined how far the closed container is compressed laterally by this force (distance in mm). This simulates the stiffness of the container during manual gripping.

The following tools are used for the test:
Universal tensile testing machine TIRA test 28025 (Tira GmbH; Eisfelder Strasse 23/25; 96528 Schalkau, Germany) with force transducer: 1000 N
XY-coordinate table
non-elastic plastic balls with diameter of 18 mm

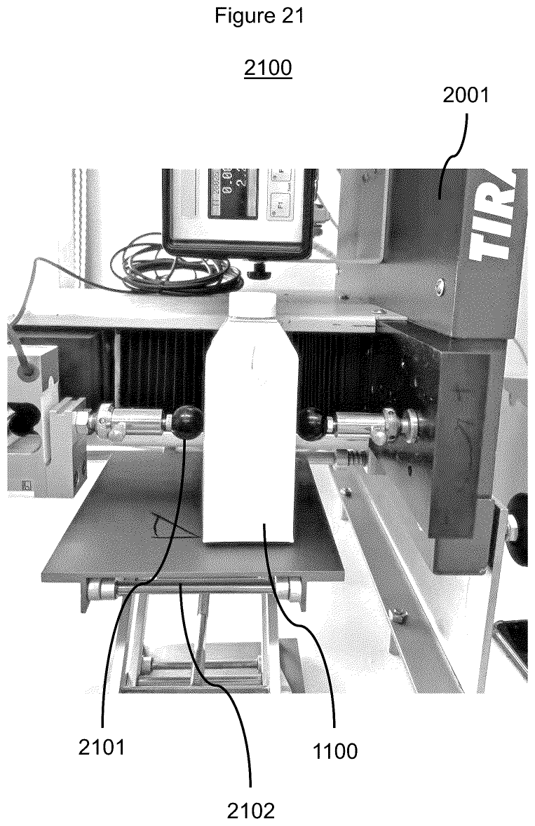

The tensile testing machine is equipped with the plastic balls. Containers of the same weight and filling level are always to be compared with the test. The test setup is shown in FIG. 21.

For each type of container to be examined, 10 containers are subjected to the test. The grip stiffness in the middle of the closed container, with respect to its total height, is determined. Corresponding pressure points, at which the plastic balls are to grip, are marked on the outside of the container before the measurement. The two pressure points are located on opposite side surfaces of the container, namely laterally in the middle of the respective side surface and in the middle of the total height of the container. After marking the pressure points, the container is aligned on the XY-coordinate table on the tensile testing machine between the two non-elastic plastic balls. The container must not yet touch the fixed plastic ball. The result of the grip stiffness test is the distance travelled when the force corresponding to the weight force of the closed container multiplied by 1.5 is reached.

### Angle (β) of the Inclination of the Head Side Surfaces to the Height of the Container

In order to determine the angle of inclination of the head side faces of a container (the side faces of the truncated pyramid), the container is fixed flat with one side on a white sheet of paper. Then one steep edge of the head side surface, whose angle of inclination is to be determined, and the adjoining longitudinal edge of the container are transferred as straight lines onto the sheet of paper with a pencil. Now measure the angle between the straight lines representing the steep edge and the longitudinal edge on the sheet of paper with a geometry set square. This measuring process is repeated for the other steep edge of the same head side surface. The angle of inclination of this head side surface is then the mean value of the angles determined for the two steep edges.

The invention is described in more detail below by means of examples and drawings, whereby the examples and drawings do not imply any limitation of the invention. Furthermore, the drawings are not to scale unless otherwise indicated.

### Laminate Structure

In the examples (according to the invention) and comparative examples (not according to the invention), laminates with the layer structure shown in Table 1 below are used for container production.

TABLE 1
Structure of the laminates of the examples
and the comparative examples

| | | Basis |
|---|---|---|
| | | weight |
| Layer | Material | [g/m²] |
| Outer polymer | LDPE 23L430 from Ineos GmbH, | 15 |
| layer | Cologne, Germany | |
| Carrier layer | Cardboard: Stora Enso Natura T Duplex | 220 |
| | double paper coating, Scott-Bond 200 | |
| | J/m², residual moisture content 7.5% | |
| Intermediate | LDPE 23L430 from Ineos GmbH, | 18 |
| polymer layer | Cologne, Germany | |
| Adhesion | Escor 6000 HSC from Exxon Mobil | 3 |
| promoter layer | Corporation | |
| Barrier layer | Aluminium, EN AW 8079 from Hydro | here: thick- |
| | Aluminium Deutschland GmbH | ness 6 μm |
| Inner polymer | LDPE 23L430 from Ineos GmbH, | 45 |
| layer | Cologne, Germany | |

### Laminate Production

The laminates for the examples and comparative examples are produced using a melt extrusion coating line from Davis Standard. Here, the extrusion temperature is in a range of approx. 280 to 330° C. In the first step, a hole is made in the carrier layer, which is provided as roll material, for each container to be produced, and then the outer polymer layer is applied to the full surface of the carrier layer by melt extrusion coating. Furthermore, the barrier layer, together with the adhesion promoter layer and the intermediate polymer layer as laminating agents, is applied over the entire surface of the carrier layer previously coated with the outer polymer layer. Subsequently, the inner polymer layer is extrusion coated over the entire surface of the barrier layer. To apply the individual layers by melt extrusion coating, the polymers are melted in an extruder. When applying a polymer in a layer, the resulting melt is transferred via a feed block into a die and extruded onto the carrier layer.

### Container Production

Groove patterns are introduced into the web-shaped laminate obtained as described above on the outer side. Each groove pattern consists of a plurality of grooves with 4 longitudinal grooves of equal length. Further, the grooved web-shaped laminate is divided into blanks for individual containers, each blank having one of the above holes and one of the groove patterns. By folding along longitudinal grooves of the groove pattern of each blank and sealing overlapping fold surfaces to one another, a sleeve-like container precursor is obtained from the blank.

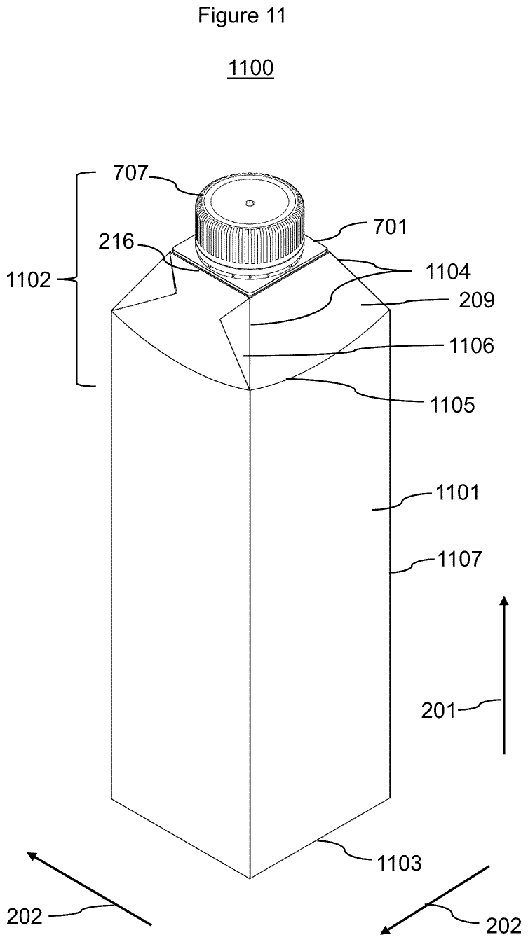

Closed containers are produced from the container precursors obtained as described above. Within the scope of the comparative examples and examples, both cuboid-shaped containers and containers with a cuboid-shaped body and a truncated pyramid-shaped head portion arranged thereon are produced. The latter container shape is basically shown in FIG. 11. The body of both container shapes has a square cross-section with edge length a. For both container shapes, containers with edge lengths of a=67.5 mm and a=47.5 mm are produced.

The following filling machines are used for the production of the various containers.

TABLE 2
Filling machines to be used for the
comparative examples and examples

| Container shape [cuboid | | |
|---|---|---|
| with/without | Edge length a | |
| truncated pyramid] | [mm] | Filling machine |
| without truncated pyramid | 67.5 | CFA 812-36, SIG |
| | | Combibloc, Linnich |
| without truncated pyramid | 47.5 | CFA 1724-37, SIG |
| | | Combibloc, Linnich |
| with truncated pyramid | 67.5 | CDA 1012-36, SIG |
| | | Combibloc, Linnich |
| with truncated pyramid | 47.5 | CDA 2012-39, SIG |
| | | Combibloc, Linnich |

To produce the cuboid-shaped containers without a truncated pyramid-shaped head portion, the sleeve-like container precursor is first folded into a cuboid shape and a bottom area is created by folding, which is closed by heat sealing with hot air. This creates a cup that is open at the top. The cup is sterilised with hydrogen peroxide. Furthermore, the cup is filled with water. The top area of the cup, which contains the hole, is closed by folding and ultrasonic sealing. Then the head portion is formed by folding in such a way that a closed container in cuboid shape is obtained. The fold protrusions, called ears, are sealed to the body of the container with hot air. An opening aid is glued onto the container in the area of the hole.

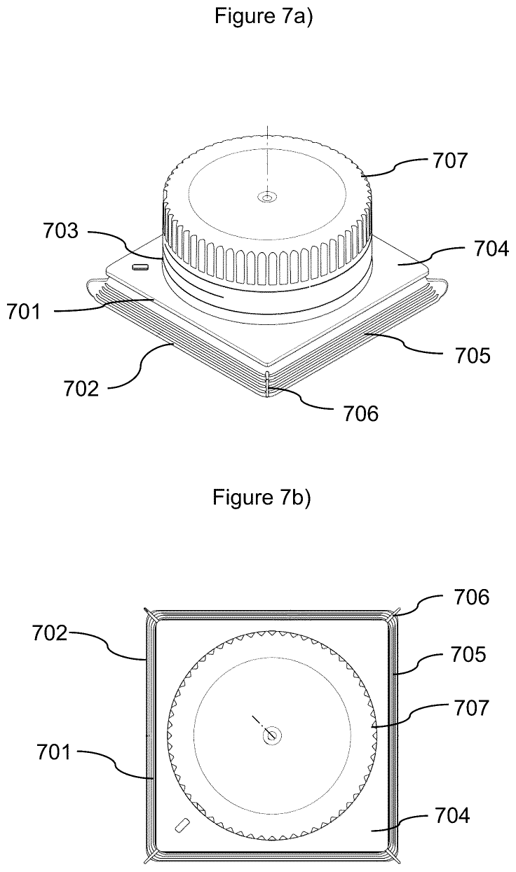

To produce the cuboid-shaped containers with a truncated pyramid-shaped head portion, the sleeve-like container precursor is also first folded into a cuboid shape. Then the truncated pyramid-shaped head portion is folded and joined to an injection moulded part of the shape shown in FIGS. 7a) and 7b) by heat sealing with hot air. In this process, the fold protrusions, called ears, are sealed to the side surfaces of the head portion. The resulting container, open at the bottom, is sterilised with hydrogen peroxide. Furthermore, the open container (upside down) is filled with water. The bottom area of the container is closed by folding and ultrasonic sealing, thus obtaining a closed container in the shape of a cuboid with a truncated pyramid-shaped head portion.

### Evaluation

Firstly, the influence of the length 1 of the longitudinal edges of the container formed along the longitudinal grooves on basic usage properties of the container is studied while the edge length a remains constant. The length 1 is determined as the length of the longitudinal grooves in the groove pattern of the respective container. It denotes the height of the container without any truncated pyramid-shaped head portion. The table below summarises the results for both edge lengths a considered, for containers with a truncated pyramid-shaped head portion as well as without a truncated pyramid-shaped head portion. The data in Table 3 for containers with edge length a=67.5 mm thus refer to both, containers with a truncated pyramid-shaped head portion and those without a truncated pyramid-shaped head portion. Likewise, the data for containers with an edge length of a=47.5 mm refer to both, containers with a truncated pyramid-shaped head portion and those without a truncated pyramid-shaped head portion.

TABLE 3
On the influence of the height of the container
body on the use properties of the container

| a [mm] | l [mm] | l/a | Standing stability | Capacity | Grip stiffness |
|---|---|---|---|---|---|
| 67.5 | 87.5 | 1.296 | ++ | − | + |
| 67.5 | 94.0 | 1.393 | + | + | + |
| 67.5 | 189 | 2.8 | + | + | + |
| 67.5 | 202.5 | 3.0 | − | ++ | + |
| 47.5 | 61.5 | 1.295 | ++ | −− | ++ |
| 47.5 | 66 | 1.389 | + | 0 | ++ |
| 47.5 | 133 | 2.8 | + | 0 | ++ |
| 47.5 | 142.5 | 3.0 | − | + | ++ |

It is found that a ratio l/a of less than 1.3 leads to low capacities. A ratio l/a of more than 2.95 always has a detrimental effect on the standing stability of the containers, i.e., the containers tend to fall over easily. Containers with a ratio l/a in the range of 1.35 to 2.95 are always sufficiently standing-stable and have sufficient capacities. In this range, i.e., with sufficient standing stability, the larger edge length a allows a larger capacity. On the other hand, the smaller edge length a allows a particularly good grip stiffness with sufficient standing stability. These containers are particularly easy to handle. While containers with a larger edge length a are particularly suitable for stationary household use, containers with a smaller edge length a are particularly suitable for mobile use.

In the following, the influence of the angle α on the compression stability of containers with sufficient stability as well as on the sealing of the fold protrusions (1106 in FIG. 11), often referred to as ears by those skilled in the art, is considered. The angle α is the angle that is included by the grooves of the two steep edges of each side face of the truncated pyramid-shaped head portion. This angle is measured in the plane of the laminate as described above before the container is made. The containers with a truncated pyramid-shaped head portion to be considered here all have exclusively straight, i.e., not curved, base edges of the head portion.

The results summarised in Table 4 show that containers according to the invention with a truncated pyramid-shaped head portion are more compression-resistant along their length than conventional rectangular containers without a truncated pyramid-shaped head portion. This makes such containers more suitable for stacking for transport. This helps to make the transport of filled containers to retailers more efficient. Furthermore, the selection of the angle α according to the invention improves the sealing of the ears. If the angle α is not selected according to the invention, errors in the sealing of the ears occur more frequently, which can lead to ears not being fully attached. This can lead to production errors in the filling machine and thus to interruptions in production.

TABLE 4
On the influence of the angle α on the compression stability and the sealing of the ears

| | Container shape | | | | | | |
|---|---|---|---|---|---|---|---|
| | [Cuboid with/without | | | | | Sealing of | Compression |
| Example | truncated pyramid] | a [mm] | l [mm] | l/a | α [°] | the ears | stability |
| Comparative example 1 | without truncated pyramid | 67.5 | 94.0 | 1.393 | / | + | − |
| Comparative example 2 | without truncated pyramid | 67.5 | 189 | 2.8 | / | + | − |
| Comparative example 3 | without truncated pyramid | 47.5 | 66 | 1.389 | / | + | − |
| Comparative example 4 | without truncated pyramid | 47.5 | 133 | 2.8 | / | + | − |
| Comparative example 5 | with truncated pyramid | 67.5 | 94.0 | 1.393 | 39 | − | − |
| Example 1 | with truncated pyramid | 67.5 | 94.0 | 1.393 | 40 | + | 0 |
| Example 2 | with truncated pyramid | 67.5 | 94.0 | 1.393 | 45 | ++ | ++ |
| Example 3 | with truncated pyramid | 67.5 | 94.0 | 1.393 | 54 | + | + |
| Example 4 | with truncated pyramid | 67.5 | 94.0 | 1.393 | 60 | + | 0 |
| Comparative example 6 | with truncated pyramid | 67.5 | 94.0 | 1.393 | 61 | − | − |
| Comparative example 7 | with truncated pyramid | 67.5 | 189 | 2.8 | 39 | − | − |
| Example 5 | with truncated pyramid | 67.5 | 189 | 2.8 | 40 | + | 0 |
| Example 6 | with truncated pyramid | 67.5 | 189 | 2.8 | 45 | ++ | ++ |
| Example 7 | with truncated pyramid | 67.5 | 189 | 2.8 | 54 | + | + |
| Example 8 | with truncated pyramid | 67.5 | 189 | 2.8 | 60 | + | 0 |
| Comparative example 8 | with truncated pyramid | 67.5 | 189 | 2.8 | 61 | − | − |
| Comparative example 9 | with truncated pyramid | 47.5 | 66 | 1.389 | 39 | − | − |
| Example 9 | with truncated pyramid | 47.5 | 66 | 1.389 | 40 | + | 0 |
| Example 10 | with truncated pyramid | 47.5 | 66 | 1.389 | 45 | + | + |
| Example 11 | with truncated pyramid | 47.5 | 66 | 1.389 | 54 | ++ | ++ |
| Example 12 | with truncated pyramid | 47.5 | 66 | 1.389 | 60 | + | 0 |
| Comparative example 10 | with truncated pyramid | 47.5 | 66 | 1.389 | 61 | − | − |
| Comparative example 11 | with truncated pyramid | 47.5 | 133 | 2.8 | 39 | − | − |
| Example 13 | with truncated pyramid | 47.5 | 133 | 2.8 | 40 | + | 0 |
| Example 14 | with truncated pyramid | 47.5 | 133 | 2.8 | 45 | + | + |
| Example 15 | with truncated pyramid | 47.5 | 133 | 2.8 | 54 | ++ | ++ |
| Example 16 | with truncated pyramid | 47.5 | 133 | 2.8 | 60 | + | 0 |
| Comparative example 12 | with truncated pyramid | 47.5 | 133 | 2.8 | 61 | − | − |

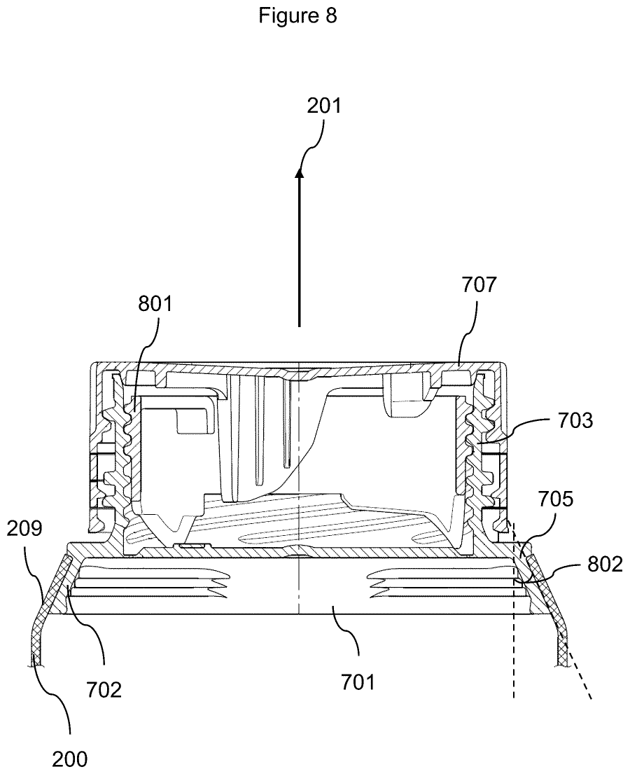

In further examples, the influence of a curvature of the base edges of the truncated pyramid-shaped head portion on the shelf life of the containers and the sealing of the ears as well as on the effects on the production process described above are examined. For this purpose, containers with a truncated pyramid-shaped head portion with a straight base edge are compared with containers with a truncated pyramid-shaped head portion whose base edges are convexly curved in relation to the respective side surface of the head portion (cf. 1105 in FIG. 11). The angle β, which indicates the inclination of the side surfaces of the truncated pyramid-shaped head portion of the container in relation to the longitudinal direction (height) of the container (cf. 802 in FIG. 8), is always 55° here, so that an influence of this angle on the examinations can be excluded (cf. also Tables 6 and 7).

TABLE 5
On the influence of a curvature of the base edges of the truncated pyramid-
shaped head portion on the shelf life and the sealing of the ears

| | | | | | | Liquid tightness | Sealing of |
|---|---|---|---|---|---|---|---|
| | a [mm] | l [mm] | l/a | α [°] | Base edges | of the head portion | the ears |
| Example 17 | 67.5 | 94.0 | 1.393 | 45 | straight | 0 | ++ |
| Example 18 | 67.5 | 189 | 2.8 | 45 | straight | 0 | ++ |
| Example 19 | 67.5 | 94.0 | 1.393 | 45 | convexly curved | + | +++ |
| Example 20 | 67.5 | 189 | 2.8 | 45 | convexly curved | + | +++ |
| Example 21 | 47.5 | 66 | 1.389 | 54 | straight | 0 | ++ |
| Example 22 | 47.5 | 133 | 2.8 | 54 | straight | 0 | ++ |
| Example 23 | 47.5 | 66 | 1.389 | 54 | convexly curved | + | +++ |
| Example 24 | 47.5 | 133 | 2.8 | 54 | convexly curved | + | +++ |

Furthermore, the influence of the angle β, at which the side surfaces of the truncated pyramid-shaped head portion of the container are inclined to the longitudinal direction (height) of the container (cf. 802 in FIG. 8), on the shelf life of the containers is considered. For this purpose, containers with truncated pyramid-shaped head portions with curved base edges are manufactured according to Examples 19, 20, 23 and 24, whereby their angle β is varied. It is found that angles β in the range from 55 to 70° are beneficial for the shelf life of the containers. Analyses of the containers show that angles β outside the aforementioned range promote the formation of so-called pockets, i.e., unsealed cavities, on the interfaces between the laminate and the moulded part in the head portion. Such cavities reduce the tightness of the head portion. This can be proven with the “liquid tightness” test described above. Furthermore, germs can increasingly hold and multiply in such cavities. Both reduced tightness and increased germ growth shorten the shelf life of the containers.

TABLE 6
On the influence of the angle β on the shelf life
of containers with edge length a = 67.5 mm

| | a, l, l/a, | | Liquid tightness of |
|---|---|---|---|
| | α, base edges | β [°] | the head portion |
| Example 25 | see example 19 | 54 | − |
| Example 26 | see example 19 | 55 | + |
| Example 27 | see example 19 | 59 | ++ |
| Example 28 | see example 19 | 66 | +++ |
| Example 29 | see example 19 | 70 | + |
| Example 30 | see example 19 | 71 | − |
| Example 31 | see example 20 | 54 | − |
| Example 32 | see example 20 | 55 | + |
| Example 33 | see example 20 | 59 | ++ |
| Example 34 | see example 20 | 66 | +++ |
| Example 35 | see example 20 | 70 | + |
| Example 36 | see example 20 | 71 | − |

TABLE 7
On the influence of the angle β on the shelf life
of containers with edge length a = 47.5 mm

| | a, l, l/a, | | Liquid tightness of |
|---|---|---|---|
| | α, base edges | β [°] | the head portion |
| Example 37 | see example 23 | 54 | − |
| Example 38 | see example 23 | 55 | + |
| Example 39 | see example 23 | 59 | +++ |
| Example 40 | see example 23 | 66 | ++ |
| Example 41 | see example 23 | 70 | + |
| Example 42 | see example 23 | 71 | − |
| Example 43 | see example 24 | 54 | − |
| Example 44 | see example 24 | 55 | + |
| Example 45 | see example 24 | 59 | +++ |
| Example 46 | see example 24 | 66 | ++ |
| Example 47 | see example 24 | 70 | + |
| Example 48 | see example 24 | 71 | − |

In further examples, the influence of the orientation of the carrier layer in the container on the shelf life of the containers is studied. The carrier layer is made of cardboard, as indicated in Table 1. The latter is a material with an orientation direction. The cardboard fibres are mainly oriented in the machine direction (MD) of the cardboard production. The carrier layer, and thus the laminate containing it, has a greater bending stiffness for bending in the orientation direction of the cardboard fibres than for bending perpendicular to it. More precisely, the bending stiffness of the laminate for bending in the orientation direction has a maximum, related to the bending direction.

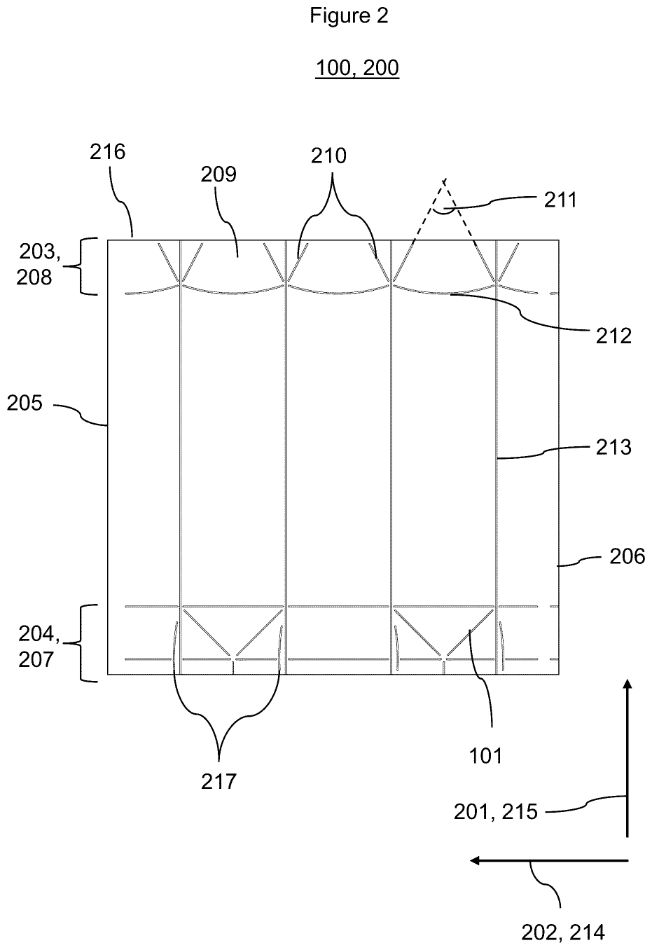

In the above examples and comparative examples of Tables 3 to 7, the orientation direction of the carrier layer is always parallel to the container height. In the further examples below, cuboid containers with truncated pyramid-shaped head portions are considered, in which the predominant fibre direction of the carrier layer is oriented perpendicular or parallel to the upper laminate edge. The upper laminate edge in this case is the edge of the laminate that runs around the moulded part (cf. 216 in FIGS. 2 to 6 and 11).

TABLE 8
On the influence of the orientation of the carrier
layer in the container on its shelf life

| | | Fibre direction | |
|---|---|---|---|
| | a, l, l/a, α, | to the upper | Liquid tightness |
| | base edges, β | laminate edge | of the head portion |
| Example 49 | see example 28 | perpendicular | +++ |
| Example 50 | see example 28 | parallel | ++++ |
| Example 51 | see example 34 | perpendicular | +++ |
| Example 52 | see example 34 | parallel | ++++ |
| Example 53 | see example 39 | perpendicular | +++ |
| Example 54 | see example 39 | parallel | ++++ |
| Example 55 | see example 45 | perpendicular | +++ |
| Example 56 | see example 45 | parallel | ++++ |

It is observed that an alignment of the fibre direction parallel to the upper laminate edge, i.e., perpendicular to the container height, has a beneficial effect on the shelf life of the containers. In particular, it is found that the seal between the laminate and the moulded part is tighter when the fibre direction is aligned parallel to the upper edge of the laminate. This can be demonstrated with the “liquid tightness” test described above. The reason for this may be less cardboard dust on the sealing surfaces. Such dust from inside the cardboard can also lead to contamination of the container interior. Both the reduced tightness of the seal between the laminate and the moulded part and contamination of the container interior with dust have a detrimental effect on the shelf life of the containers. Production tolerances in the orientation of the carrier layer show that the fibre direction does not need to be exactly parallel to the upper laminate edge to achieve the advantageous effect on the shelf life.

In the above Tables 3 to 8:
“++++” means a more favourable result than “+++”,
“+++” means a more favourable result than “++”,
“++” means a more favourable result than “+”,
“+” means a more favourable result than “0”,
“0” means a more favourable result than “−”, and
“−” means a more favourable result than “−−”.

Unless otherwise stated in the description or the respective figure, the figures schematically and not to scale show:

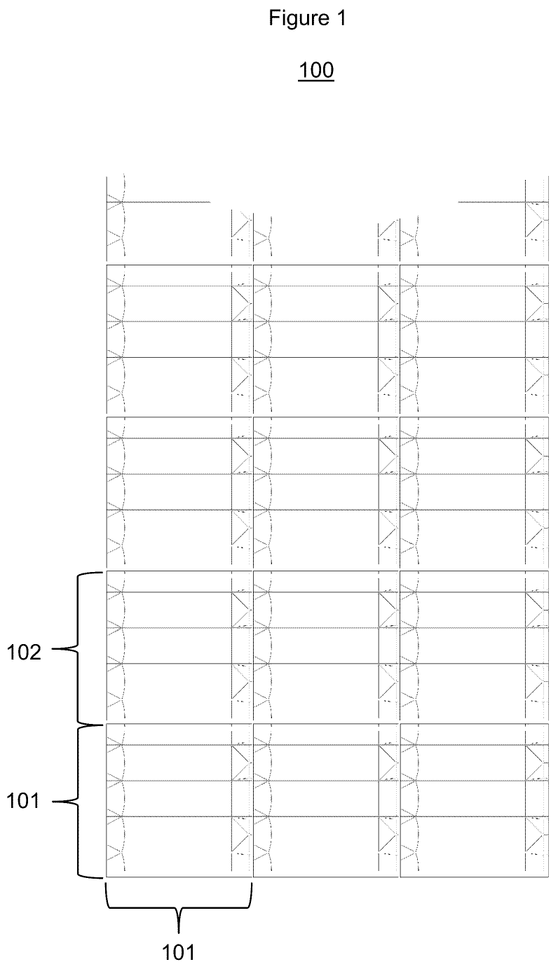

FIG. 1 a schematic representation of a planar composite according to the invention;

FIG. 2 a schematic representation of a further planar composite according to the invention;

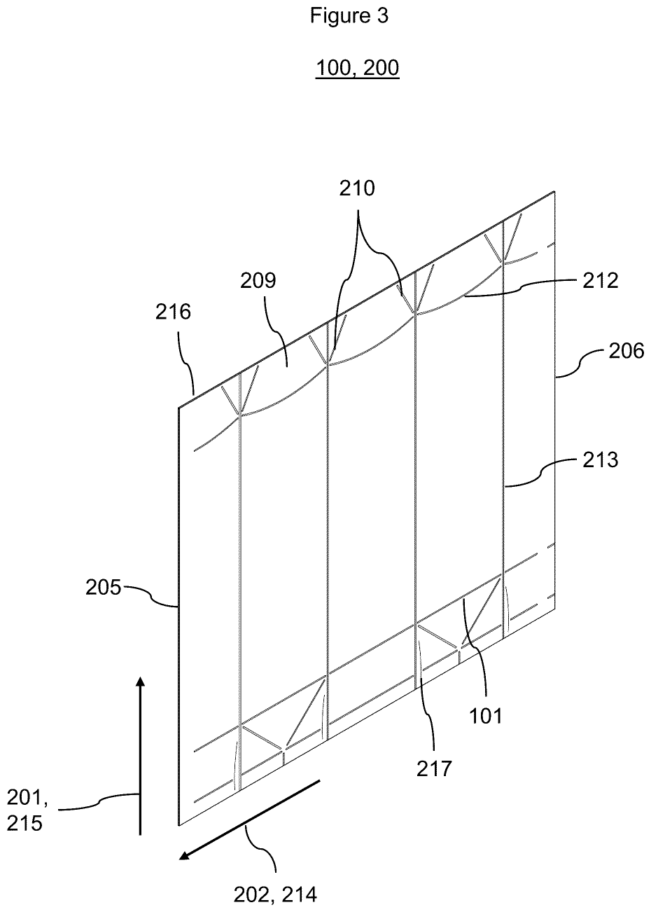

FIG. 3 a further schematic representation of the planar composite according to the invention of FIG. 2;

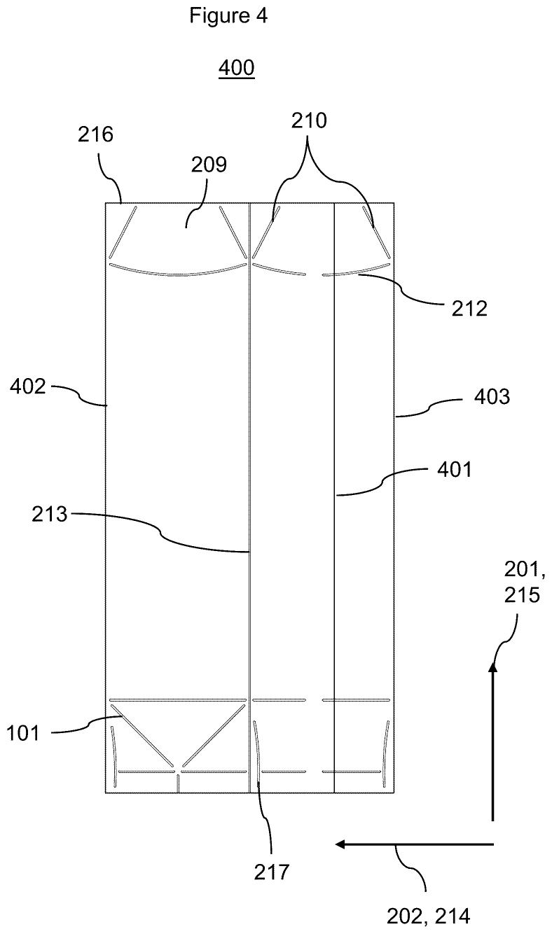

FIG. 4 a schematic representation of a container precursor according to the invention;

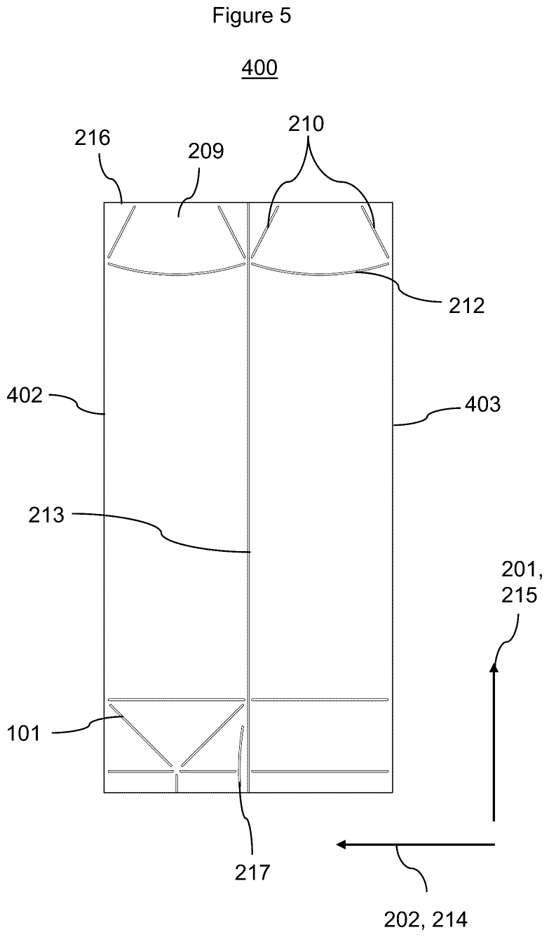

FIG. 5 a further schematic representation of the container precursor according to the invention of FIG. 4;

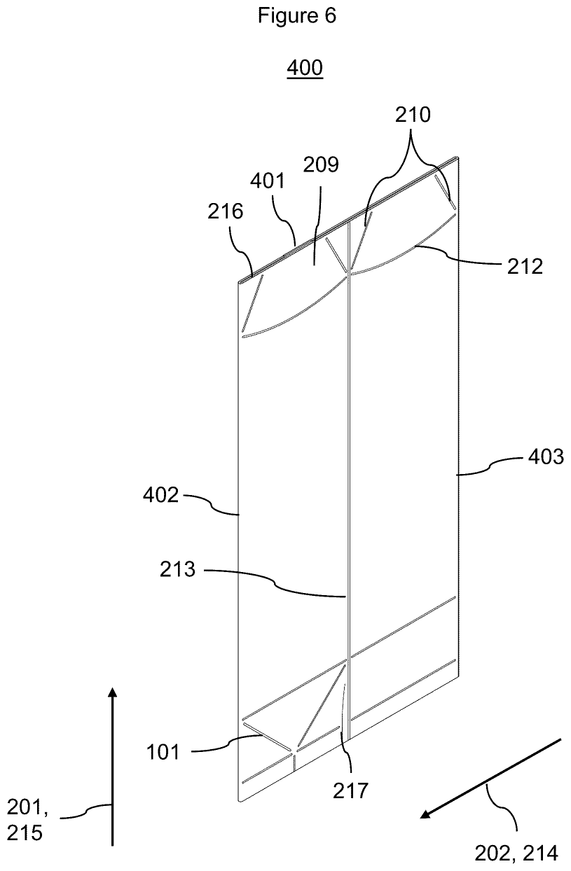

FIG. 6 a further schematic representation of the container precursor according to the invention of FIG. 4;

FIG. 7a) a schematic perspective view of an element other than the planar composite or blank with cap;

FIG. 7b) a schematic top view of the element other than the planar composite or blank with cap of FIG. 7a);

FIG. 8 a schematic sectional view of the element other than the planar composite or blank with cap of FIG. 7a);

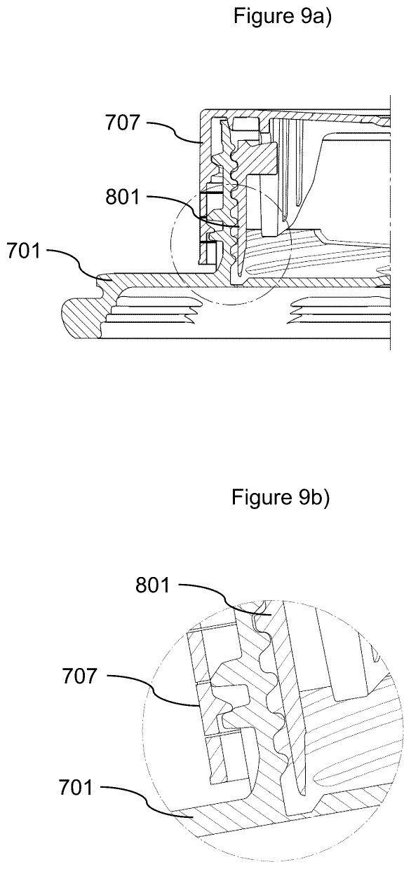

FIG. 9a) a schematic partial view of a further section through the element other than the planar composite or blank with cap of FIG. 7a):

FIG. 9b) an enlarged partial representation of FIG. 9a);

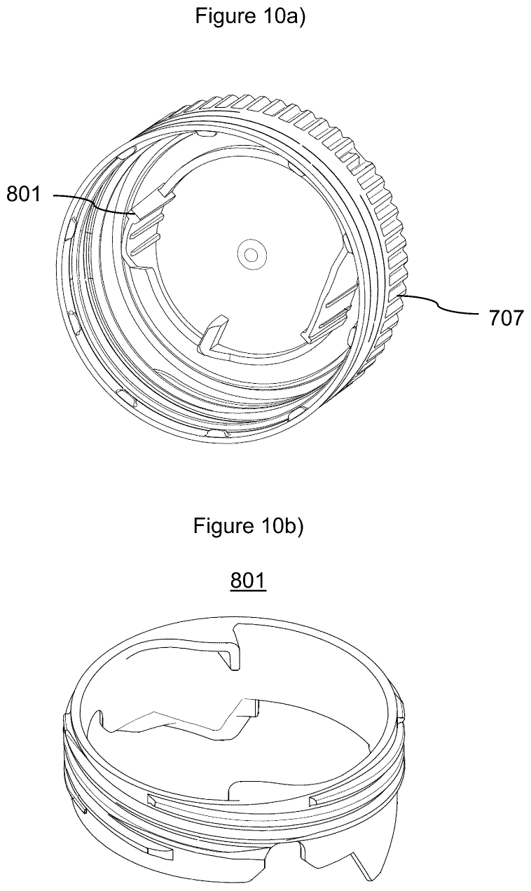

FIG. 10a) a schematic representation of the cap of FIG. 7a) with opening aid:

FIG. 10b) a schematic representation of the opening aid from FIG. 10a):

FIG. 11 a schematic perspective view of a closed container according to the invention:

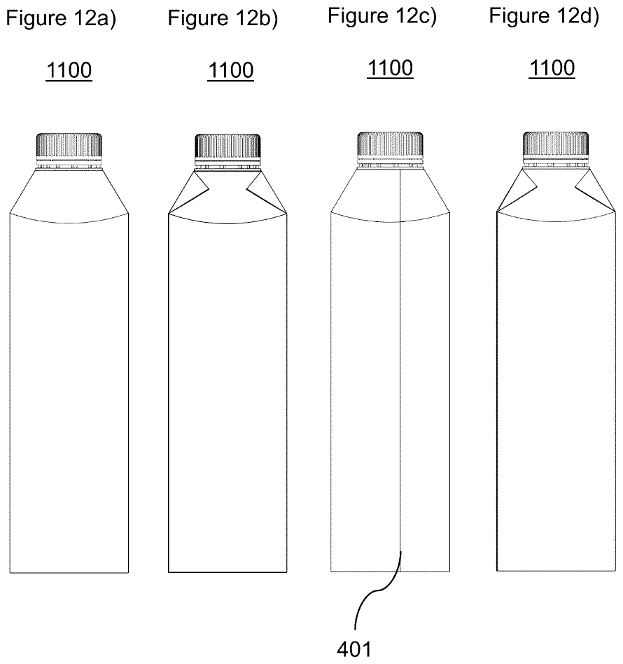

FIGS. 12a) to 12d) schematic side views of the closed container according to the invention from FIG. 11:

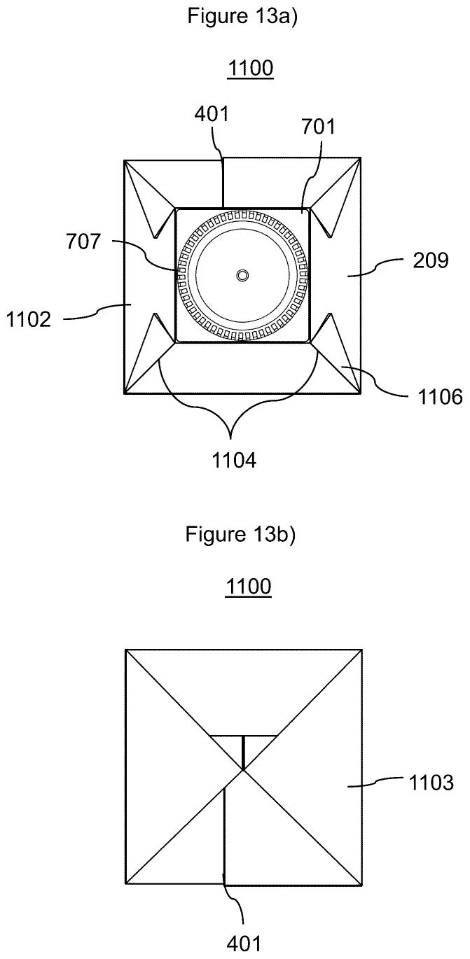

FIG. 13a) a schematic top view of the closed container according to the invention from FIG. 11:

FIG. 13b) a schematic bottom view of the closed container according to the invention from FIG. 11:

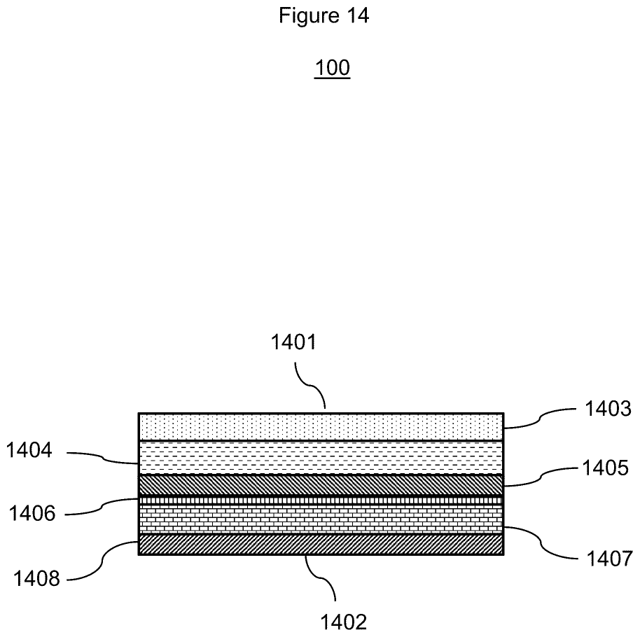

FIG. 14 a schematic partial representation of a section through a planar composite according to the invention:

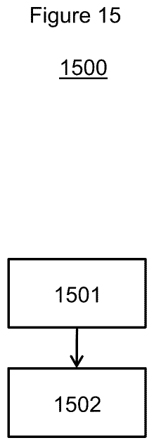

FIG. 15 a flow chart of a process according to the invention for producing a planar composite:

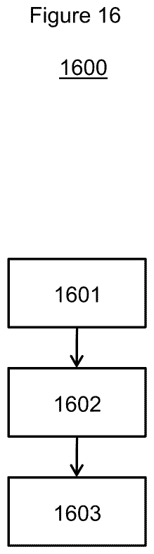

FIG. 16 a flow chart of a process according to the invention for manufacturing a container precursor:

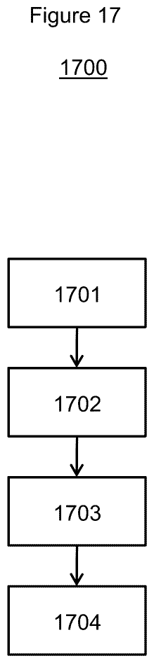

FIG. 17 a flow chart of a process according to the invention for producing a closed container:

FIGS. 18a) to 18f) illustrations of the preparation of a closed container to determine the angle of a pair of steep edges:

FIG. 19 an illustration of the test method for determining the angle of a pair of steep edges:

FIG. 20 a test setup to determine compression stability; and

FIG. 21 a test setup to determine the grip stiffness.

FIG. 1 shows a schematic top view of a planar composite 100 according to the invention. The planar composite 100 is a semi-endless roll material, of which here only a section can be shown.

The planar composite 100 comprises a first plurality of grooves 101 and more than 50 further pluralities of grooves 102.

FIG. 2 shows a schematic plan view of a further planar composite 100 according to the invention. This is a blank 200 of the planar composite 100 of FIG. 1. This blank 200 includes only the first plurality of grooves 101. These grooves are arranged and configured such that by folding the blank 200 along the grooves of the first plurality of grooves 101 and joining portions of the blank 200, a first part of a container wall 1101 of the closed container 1100 of FIG. 11 is obtainable. This closed container 1100 includes a standing base 1103 and, in a longitudinal direction 201, extending along a length of the closed container 1100, opposite the standing base 1103, a head portion 1102. Accordingly, the first plurality of grooves 101 includes grooves 204 in a first transverse margin 207 to form the standing base 1103 and grooves 203 in a further transverse margin 208 to form the head portion 1102. Furthermore, the first plurality of grooves 101 includes exactly 4 longitudinal grooves 213 for forming 4 longitudinal edges 1107 of the closed container 1100. The latter includes 4 head side surfaces 209 formed from the blank 200. The head side surfaces 209 are inclined to each other in the longitudinal direction 201 in such a way that the closed container 1100 tapers in the head portion 1102. The 4 head side surfaces 209 together form substantially a lateral surface of the head portion 1102, which is substantially in the shape of a regular truncated pyramid with a square base. The 4 base edges 1105 of the regular truncated pyramid are convexly curved towards the standing base 1103, relative to their respective head side surfaces 209. The first plurality of grooves 101 includes 4 corresponding grooves 212 for forming the 4 base edges 1105. A perimeter of each of the 4 head side surfaces 209 is formed by a respective plurality of side edges of the head portion 1102. Each of these pluralities of side edges includes a pair of steep edges 1104 opposing each other in a circumferential direction 202 of the closed container 1100 perpendicular to the longitudinal direction 201. Each pair of steep edges 1104 is formed along a pair of grooves 210 of the first plurality of grooves 101. The grooves of each of these pairs of grooves 201 extend in a plane of planar extension of the blank 200 at an angle 211 in the range of 40 to 60° with respect to each other. This angle 211 is also referred to herein as a. The blank 200 has a first longitudinal margin 205, a further longitudinal margin 206 opposite thereto in the circumferential direction 202, the first transverse margin 207 and the further transverse margin 208 opposite thereto in the longitudinal direction 201. Each of the first longitudinal margin 205, the further longitudinal margin 206, the first transverse margin 207 and the further transverse margin 208 includes a cut edge of the blank 200. A bending stiffness of the planar composite 100 for bending in a first composite direction 214 is greater than for bending in a further composite direction 215 perpendicular to the first composite direction 214. Therein, the first composite direction 214 as well as the further composite direction 215 lie in the plane of planar extension of the planar composite 100. The further transverse margin 208 is arranged and configured to provide a first part of the head portion 1102 of the closed container 1100 by folding the further transverse margin 208 along grooves of the first plurality of grooves 101 and joining portions of the further transverse margin 208 with one another. The edge 216 of the further transverse margin 208 surrounds a further part of the head portion 1102 in the closed container 1100. The edge 216 runs along its entire length parallel to the first composite direction 214 (cf. FIG. 11). The first plurality of grooves 101 further comprises 4 auxiliary grooves 217. Each of the auxiliary grooves 217 is arranged next to one of the longitudinal grooves 213 in the first transverse margin 207 such that a bending radius of a longitudinal fold along this longitudinal groove 213 is increased at least in sections of the longitudinal fold. Further, each of the auxiliary grooves 217 is curved away from the respective longitudinal groove 213. Furthermore, each of the auxiliary grooves 217 is arranged on a side of the respective longitudinal groove 213 which faces away from a centre of the blank 200, based on the circumferential direction 202. Forming the standing base 1103 includes particularly severe folding of the blank 200. The auxiliary grooves 217 described above allow to reduce mechanical stress to the blank 200 upon forming the standing base 1103. This helps to reduce the risk of leaks at the bottom of the container 1100 and, thus, contributes to a long shelf life.

FIG. 3 shows a schematic perspective view of the blank 200 of FIG. 2.

FIG. 4 shows a schematic top view of a container precursor 400 according to the invention. This includes the blank 200 of FIG. 2. Here, the blank 200 has a first longitudinal fold 402 and a further longitudinal fold 403, both along longitudinal grooves 213. The container precursor 400 is folded flat along these longitudinal folds. The first longitudinal margin 205 and the further longitudinal margin 206 of the blank 200 are sealed together forming a longitudinal seam 401 of the container precursor 400.

FIG. 5 shows a further schematic top view of the container precursor 400 according to the invention of FIG. 4. Here, the container precursor 400, which continues to be folded flat, can be seen from the side opposite the longitudinal seam 401.

FIG. 6 shows a schematic perspective view of the container precursor 400 of FIG. 4 according to the invention.

FIG. 7a) shows a schematic perspective view of an element 701 other than the planar composite 100 or the blank 200 together with a cap 707. This element 701 is a non-planar component, more specifically a moulded component, which forms a further part of the container wall 1101 in the closed container 1100 of FIG. 11, while the blank 200 of FIG. 2 forms the first part, which is an open, cup-shaped container, so that the container 1100 is closed. The further part of the container wall 1101 is encompassed by the head portion 1102 of the closed container 1100. The element 701 bounds the container interior in the longitudinal direction 201 and forms a top surface of the truncated pyramid-shaped head portion 1102. The element 701 is made of HDPE, includes a base member 702 and a spout 703 arranged thereon, a pouring aperture of which is closed by the cap 707. The cap 707 is screwed onto the spout 703. The cap 707 is also made of HDPE. The base member 702 includes a base plate 704 and exactly 4 side walls 705. The spout 703 is arranged on a first side of the base plate 704. The side walls 705 are arranged on a further side of the base plate 704 opposite the first side. In each case, 2 of the side walls 705 adjoin one another forming a side edge 706 of the base member 702. The element 701 is formed in one piece and is obtainable by injection moulding.

FIG. 7b) shows a schematic top view of the element 701 and the cap 707 of FIG. 7a).

FIG. 8 shows a schematic sectional view of the element 701 and the cap 707 of FIG. 7a). Here, it can be seen that an opening aid 801 in the form of a cutting ring 801 is arranged in the spout 703. The cutting ring 801 is made of PP. Furthermore, the element 701 here is joined to the blank 200 of FIG. 2, forming the closed container 1100 of FIG. 11. It can be seen that the side walls 705 of the element 701 and also the head side surfaces 209 of the closed container 1100 are inclined to each other in the longitudinal direction 201 in such a way that they include an angle 802 in a range of 55 to 70° with the longitudinal direction 201. This angle 802 is also referred to herein as β.

FIG. 9a) shows a schematic partial view of a further section through the element 701 and the cap 707 of FIG. 7a).

FIG. 9b) shows an enlarged partial representation of the circled area of FIG. 9a).

FIG. 10a) shows a schematic representation of the cap 707 of FIG. 7a) with the opening aid 801.

FIG. 10b) shows a schematic representation of the opening aid 801 from FIG. 10a).

FIG. 11 shows a schematic perspective view of a closed container 1100 according to the invention. The closed container 1100 comprises a container wall 1101 surrounding a container interior. A first part of the container wall 1101 is formed by the blank 200 of FIG. 2. A further part of the container wall 1101 is formed by the element 701 of FIG. 7a). The blank 200 and the element 701 are joined to one another by heat sealing. The closed container 1100 includes a standing base 1103 and, in the longitudinal direction 201, extending along the length of the closed container 1100, opposite the standing base 1103, a head portion 1102. The head portion 1102 includes exactly 4 head side surfaces 209 formed from the blank 200, which are inclined relative to each other in the longitudinal direction 201 such that the closed container 1100 tapers in the head portion 1102 in the longitudinal direction 201. A perimeter of each of the head side surfaces 209 is respectively formed by a plurality of side edges of the head portion 1102. Each of these pluralities of side edges includes a pair of steep edges 1104 opposing each other in a circumferential direction 202 of the closed container 1100, which runs perpendicular to the longitudinal direction 201. The steep edges of each pair of steep edges 1104 of each of the head side surfaces 209 extend in a plane of the respective head side surface 209 at an angle in the range of 40 to 60° with respect to each other. This angle corresponds to the angle 211 in FIG. 2, and may be determined as shown in FIGS. 18a) to 18f) and 19. The closed container 1100 has 4 longitudinal edges 1107. Each of the head side surfaces 209 includes an angle 802 (cf. FIG. 8) in the range of 55 to 70° with the longitudinal direction 201. The 4 head side surfaces 209 together form substantially a lateral surface of the head portion 1102, which is substantially in the form of a regular truncated pyramid with a square base. The 4 base edges 1105 of the regular truncated pyramid are convexly curved towards the standing base 1103, relative to their respective head side surfaces 209. Fold protrusions 1106, also referred to as ears 1106, are sealed to the head side surfaces 209 by hot air sealing. FIG. 11 shows the first part of the head portion 1102 obtained by folding the further transverse margin 208 of the blank 200 along grooves 203 of the first plurality of grooves 101 and joining portions of the further transverse margin 208 to one another. In the closed container 1100, the edge 216 of the further transverse margin 208 surrounds the further part of the head portion 1102. This further part of the head portion 1102 is formed by the element 701. The edge 216 runs along its entire length parallel to the first composite direction 214.

FIGS. 12a) to 12d) show schematic side views of the closed container 1100 of the invention from FIG. 11 from all 4 sides. FIG. 12c) shows the longitudinal seam 401 of the closed container 1100.

FIG. 13a) shows a schematic top view of the closed container 1100 according to the invention from FIG. 11.

FIG. 13b) shows a schematic bottom view of the closed container 1100 of FIG. 11 according to the invention.

FIG. 14 shows a schematic partial representation of a section through a planar composite 100 according to the invention. The planar composite 100 comprises, as superimposed layers of a layer sequence in the direction from an outer side 1401 of the planar composite 100 to an inner side 1402 of the planar composite 100, an outer polymer layer 1403, a carrier layer 1404, an intermediate polymer layer 1405, an adhesion promoter layer 1406, a barrier layer 1407 and an inner polymer layer 1408. The planar composite 100 of FIG. 1 has the aforementioned layer structure. Accordingly, the blank 200 of FIG. 2 also has this layer structure. The carrier layer 1404 consists of cardboard. A main fibre direction of the cardboard in the blank 200 runs approximately parallel to the edge 216 of the further transverse margin 208.

FIG. 15 shows a flow chart of a process 1500 according to the invention for producing the planar composite 100 of FIG. 1. In a process step a) 1501, a planar composite precursor with the layer structure shown in FIG. 14 is provided. In a process step b) 1502, the first plurality of grooves 101 and the further pluralities of grooves 102 are grooved into the planar composite precursor.

FIG. 16 shows a flow chart of a process 1600 according to the invention for producing the container precursor 400 of FIG. 4. In a process step a. 1601, the blank 200 of FIG. 2 is provided. In a process step b. 1602, the blank 200 is folded along its longitudinal grooves 213. In a process step c. 1603, the first longitudinal margin 205 and the further longitudinal margin 206 are contacted with each other and joined together by heat sealing, so that a longitudinal seam 401 is obtained.

FIG. 17 shows a flow chart of a process 1700 according to the invention for producing the closed container 1100 of FIG. 11. In a process step A) 1701, the container precursor 400 of FIG. 4 is first provided. Then, in a process step B) 1702, the head portion 1102 is formed and closed by folding and joining the container precursor 400 to the element 701. In a process step C) 1703, the container precursor 400, which is open at the bottom, is filled upside down with a foodstuff. Further, in a process step d) 1704, the standing base 1103 is formed and closed by folding the blank 200 along grooves of the first plurality of grooves 101 and sealing portions of the blank 200 together to obtain the closed container 1100.

FIGS. 18a) to 18f) show illustrations of the preparation of a closed container 1100 for determining the angle of a pair of steep edges 1104.

FIG. 19 shows an illustration of the test method for determining the angle of a pair of steep edges 1104.

FIG. 20 shows a test setup 2000 with a universal tensile testing machine TIRA test 28025 with force transducer 1000 N as measuring device 2001 for determining the compression stability of the closed container 1100.

FIG. 21 shows a test setup 2100 with a universal tensile testing machine TIRA test 28025 with force transducer 1000 N as measuring device 2001 for determining the grip stiffness of the closed container 1100. The tensile testing machine was equipped with 2 non-elastic plastic balls 2101 for this purpose. The closed container 1100 was positioned by means of an XY-coordinate table 2102.

### LIST OF REFERENCE SIGNS

100 Planar composite according to the invention
101 First plurality of grooves
102 Further plurality of grooves
200 Blank
201 Longitudinal direction
202 Circumferential direction
203 Grooves for forming a head portion
204 Grooves for forming a standing base
205 First longitudinal margin
206 Further longitudinal margin
207 First transverse margin
208 Further transverse margin
209 Head side surface
210 Pair of grooves for forming a pair of steep edges
211 Angle of the grooves for the pair of steep edges
212 Groove for forming a base edge
213 Longitudinal groove
214 First composite direction
215 Further composite direction
216 Edge of the further transverse margin
217 Auxiliary groove
400 Container precursor according to the invention
401 Longitudinal seam
402 First longitudinal fold
403 Further longitudinal fold
701 element other than the planar composite or the blank
702 base member
703 spout
704 base plate
705 side wall
706 side edge
707 cap
801 Opening aid/cutting ring
802 Angle between head side surfaces and longitudinal direction
1100 Closed container according to the invention
1101 Container wall
1102 Head portion
1103 Standing base
1104 Pair of steep edges
1105 Base edge
1106 Fold protrusion/ear
1107 Longitudinal edge
1401 Outer side
1402 Inner side
1403 Outer polymer layer
1404 Carrier layer
1405 Intermediate polymer layer
1406 Adhesion promoter layer
1407 Barrier layer
1408 Inner polymer layer
1500 Process according to the invention for producing a planar composite
1501 Process step a)
1502 Process step b)
1600 Process of manufacturing a container precursor according to the invention
1601 Process step a.
1602 Process step b.
1603 Process step c.
1700 Process according to the invention for manufacturing a closed container
1701 Process step A)
1702 Process step B)
1703 Process step C)
1704 Process step D)
1900 Illustration of the test method for determining the angle of the grooves of a pair of steep edges
2000 Test setup for determining the compression stability
2001 Measuring device universal tensile testing machine TIRA test 28025 with force transducer 1000 N
2100 Test setup for determining the grip stiffness
2101 Non-elastic plastic balls
2102 XY-coordinate table

1. A planar composite comprising as superimposed layers of a layer sequence in the direction from an outer side of the planar composite to an inner side of the planar composite
a. a carrier layer,
b. a barrier layer, and
c. an inner polymer layer;
wherein the planar composite comprises at least a first plurality of grooves arranged and configured such that by folding the planar composite along the grooves of the first plurality of grooves and joining portions of the planar composite, at least a part of a container wall of a closed container is obtainable;
wherein the closed container includes a standing base and, in a longitudinal direction, extending along a length of the closed container, opposite the standing base, a head portion;
wherein the head portion includes at least 3 head side surfaces formed from the planar composite, the head side surfaces being inclined to each other in the longitudinal direction such that the closed container tapers at least in sections in the head portion;
wherein a perimeter of each of the head side surfaces is respectively formed by a plurality of side edges of the head portion;
wherein each of the pluralities of side edges includes a pair of steep edges opposite to each other in a circumferential direction of the closed container perpendicular to the longitudinal direction;
wherein each pair of steep edges is formed along a pair of grooves of the first plurality of grooves;
characterised in that the grooves of each of the pairs of grooves lie in a plane of planar extension of the planar composite and, in this plane of planar extension, run at an angle in the range from 40 to 60° to one other.

2. The planar composite according to claim 1, wherein at least a part of the pluralities of side edges includes a base edge convexly curved towards the standing base with respect to the head side surface whose perimeter is formed by the side edges.

3. The planar composite according to claim 1, wherein the head side surfaces together form substantially a lateral surface of a regular truncated pyramid.

4. The planar composite according to claim 1, wherein the carrier layer comprises one selected from the group consisting of cardboard, paperboard, and paper, or a combination of at least two thereof.

5. The planar composite according to claim 1, wherein the at least 3 head side surfaces formed of the planar composite are inclined to each other in the longitudinal direction of the closed container such that each of the head side surfaces is at an angle in a range from 55 to 70° to the longitudinal direction.

6. The planar composite according to claim 1, wherein the planar composite is configured as a blank for producing the closed container;
wherein a bending stiffness of the planar composite for bending in a first composite direction is greater than for bending in a further composite direction perpendicular to the first composite direction;
wherein the blank includes a first transverse margin and a further transverse margin opposite the first transverse margin along the longitudinal direction;
wherein the further transverse margin is arranged and configured to provide a first part of the head portion of the closed container by folding the further transverse margin along grooves of the first plurality of grooves and joining portions of the further transverse margin to one another;
wherein an edge of the further transverse margin surrounds a further part of the head portion;
wherein the edge extends along at least 50% of its length at an angle in an angular range of ±30° about the first composite direction.

7. A process comprising as process steps:
a) providing a planar composite precursor comprising a carrier layer; and
b) introducing at least a first plurality of grooves into the planar composite precursor;
wherein the grooves of the first plurality of grooves are introduced such that by folding a planar composite obtained from the planar composite precursor along the grooves of the first plurality of grooves and joining portions of the planar composite, at least a part of a container wall of a closed container is obtainable;
wherein the closed container includes a standing base and, in a longitudinal direction, extending along a length of the closed container, opposite the standing base, a head portion;
wherein the head portion includes at least 3 head side surfaces formed from the planar composite, the head side surfaces being inclined to each other in the longitudinal direction such that the closed container tapers at least in sections in the head portion;
wherein a perimeter of each of the head side surfaces is respectively formed by a plurality of side edges of the head portion;
wherein each of the pluralities of side edges includes a pair of steep edges opposite to each other in a circumferential direction of the closed container perpendicular to the longitudinal direction;
wherein each pair of steep edges is formed along a pair of grooves of the first plurality of grooves;
characterised in that the grooves of each of the pairs of grooves lie in a plane of planar extension of the planar composite and, in this plane of planar extension, run at an angle in the range from 40 to 60° to one other.

8. A container precursor comprising
the planar composite according to claim 1, or a planar composite obtainable by the process according to claim 7, or
a blank of the planar composite according to claim 1 for producing a closed container.

9. A closed container comprising a container wall surrounding a container interior, the container wall being at least partially formed of
the planar composite according to claim 1, or a planar composite obtainable by the process according to claim 7, or
a blank of the planar composite according to claim 1 for producing a closed container.

10. A closed container comprising a container wall surrounding a container interior, the container wall being formed at least in part of a planar composite;
wherein the planar composite comprises, as superimposed layers of a layer sequence in a direction from an outer side of the planar composite to an inner side of the planar composite:
a. a carrier layer,
b. a barrier layer, and
c. an inner polymer layer;
wherein the closed container includes a standing base and, in a longitudinal direction, extending along a length of the closed container, opposite the standing base, a head portion;
wherein the head portion includes at least 3 head side surfaces formed of the planar composite, the head side surfaces being inclined to each other in the longitudinal direction such that the closed container tapers at least in sections in the head portion;
wherein a perimeter of each of the head side surfaces is respectively formed by a plurality of side edges of the head portion;
wherein each of the pluralities of side edges includes a pair of steep edges opposing to each other in a circumferential direction of the closed container perpendicular to the longitudinal direction;
characterised in that the steep edges of each pair of steep edges of each of the head side surfaces lie in a plane of the respective head side surface and, in this plane of the respective head side surface, run at an angle in the range from 40 to 60° to one other.

11. The closed container according to claim 9, wherein a first part of the container wall is formed from the planar composite or the blank;
wherein a further part of the container wall is formed from an element other than the planar composite or the blank.

12. The closed container according to claim 11, wherein the element other than the planar composite or the blank is a non-planar component.

13. A process, comprising as process steps
a. providing the planar composite according to claim 1, or a planar composite obtainable by the process according to claim 7, or a blank of the planar composite according to claim 1 for making a closed container, the planar composite or the blank comprising a first longitudinal margin and a further longitudinal margin;
b. folding the planar composite or blank along grooves of the at least first plurality of grooves; and
c. contacting and joining the first longitudinal margin with the further longitudinal margin to obtain a longitudinal seam.

14. A process, comprising as process steps
A) providing the container precursor according to claim 8, or a container precursor obtainable by the process according to claim 13;
B) forming and closing a head portion of the container precursor;
C) filling the container precursor with a foodstuff; and
D) forming and closing a stationary base of the container precursor by folding the planar composite or the blank along grooves of the at least first plurality of grooves and joining portions of the planar composite or the blank to one another to obtain a closed container.

15. A use of the planar composite according to claim 1, or a planar composite obtainable by the process according to claim 7, or the container precursor according to claim 8, or a container precursor obtainable by the process according to claim 13, in each case for producing a foodstuff container.
